(19) United States
(12) Patent Application Publication
(10) Pub. No.: US 2026/0292569 A1
(43) Pub. Date: Sep. 24, 2026

(54) METHOD AND APPARATUS FOR APPLYING PLURALITY OF PIECES OF ALTITUDE-BASED CONFIGURATION INFORMATION IN NEXT-GENERATION MOBILE COMMUNICATION SYSTEM

(71) Applicant: Samsung Electronics Co., Ltd., Gyeonggi-do (KR)

(72) Inventors: Sangyeob JUNG, Gyeonggi-do (KR); Weiping SUN, Gyeonggi-do (KR)

(21) Appl. No.: 19/473,323

(22) PCT Filed: May 2, 2024
(86) PCT No.: PCT/KR2024/005943

§ 371 Date: Oct. 7, 2025

(30) Foreign Application Priority Data
May 11, 2023 (KR) 10-2023-0061055

(51) Int. Cl. H04W 24/10; H04W 8/22; H04W 64/00; H04W 76/20

(52) U.S. Cl. CPC H04W 24/10; H04W 8/22; H04W 64/00; H04W 76/20

(57) ABSTRACT

The present disclosure relates to a 5G or 6G communication system for supporting a higher data transmission rate. According to one embodiment, a method performed by means of a terminal of a wireless communication system may enmprise the steps of: acquiring, from a base station, measurement configuration information including altitude-related infermation, measuring at least one cell with respect to at least one altitude on the basis of the altitude-related information, and reporting a measurement result for the at least one cell to the base station on the basis of the altitude-related information, wherein the altitude-related information includes at least ene altitude threshold value for determning whether to trigger a report for the at least ene measurement result.

### TECHNICAL FIELD

The present disclosure relates to the operation of a mobile communication system terminal and base station. More particularly, the present disclosure relates to a method and apparatus for applying a plurality of pieces of configuration information based on an altitude of a terminal.

### BACKGROUND ART

5G mobile communication technology defines a wide frequency band to enable fast transmission speed and new services, and can be implemented not only in sub 6 GHz bands, such as 3.5 gigahertz (3.5 GHz), but also in ultra-high frequency band (‘above 6 GHz’), also known as millimeter wave (mmWave), such as 28 GHz and 39 GHz. In addition, 6G mobile communication technology, which is called a system beyond 5G, is being considered to be implemented in a terahertz band (e.g., from 95 GHz to 3 terahertz (3 THz) band) to achieve a transmission speed 50 times faster and an ultra low-latency time reduced to one-tenth, compared to the 5G mobile communication technology.

The goal in the early stage of the 5G mobile communication technology is to support services and meet performance requirements for enhanced mobile broadband (eMBB), ultra-reliable low-latency communications (URLLC), and massive machine-type communications (mMTC). To achieve the goal, standardization is underway for beamforming and massive MIMO to mitigate path loss and increase a propagation range of radio waves in an ultra-high frequency band, support for various numerologies (such as an operation of multiple subcarrier spacings) and dynamic operation of slot formats for efficient utilization of ultra-high frequency resources, initial access technologies to support multi-beam transmission and wideband, definition and operation of a bandwidth part (BWP), new channel coding methods such as a low density parity check (LDPC) code for large-capacity data transmission and a polar code for high reliable transmission of control information, L2 pre-processing, network slicing to provide dedicated networks specialized to specific services, etc.

Currently, discussions are underway for improvement and performance enhancement of the initial 5G mobile communication technology in consideration of services that the 5G mobile communication technology is intended to support. Physical layer standardization is underway for technologies such as vehicle-to-everything (V2X), which assists in driving decisions of autonomous vehicles and enhances user convenience based on their own location and status information transmitted by vehicles, new radio unlicensed (NR-U), which aims for system operation meeting various regulatory requirements in unlicensed bands, NR. UE power saving, a non-terrestrial network (NTN), which is direct UE-satellite communication to secure coverage in areas where communication with terrestrial networks is impossible, and positioning.

In addition, standardization of wireless interface architecture/protocol fields is also underway for technologies such as intelligent factories (industrial Internet of Things, IIoT) that support new services through integration and convergence with other industries, integrated access and backhaul (IAB) that provides nodes to extend network service area by integrating and supporting a wireless backhaul link and an access link, mobility enhancement including conditional handover and dual active protocol stack (DAPS) handover, and 2-step RACH for NR that simplifies a random access procedure, and standardization of system architecture/service fields is also underway for 5G baseline architecture (e.g., service based architecture, service based interface) for combining network functions virtualization (NFV) and software-defined networking (SDN) technologies, mobile edge computing (MEC) that receives services based on a location of a UE, etc.

When such 5G mobile communication systems are commercialized, connected devices, experiencing explosive growth, will be linked to communication networks. Therefore, it is expected that the enhancement of the functions and performance of 5G mobile communication systems and the integrated operation of connected devices will be required. To this end, new research is scheduled to be conducted on extended reality (XR) to efficiently support augmented reality (AR), virtual reality (VR), mixed reality (MR), etc., enhancing 5G performance and reducing complexity through artificial intelligence (AI) and machine learning (ML), supporting AI services, supporting metaverse services, drone communications, etc. In addition, the advancement of the 5G mobile communication systems may provide the foundation for the development of not only 6G mobile communication technologies, including multi-antenna transmission technologies such as a new waveform, full-dimensional multiple-input multiple-output (FD-MIMO), array antennas, and large-scale antennas to ensure coverage in a terahertz band, high-dimensional spatial multiplexing technology using metamaterial-based lenses and antennas and orbital angular momentum (OAM), and reconfigurable intelligent surface (RIS) technology to enhance coverage of a terahertz band signal, but also for 6G mobile communication technologies, including full-duplex technology, AI-based communication technologies that utilize satellites and artificial intelligence (AI) from the design stage and incorporate end-to-end AI support functions to achieve system optimization to enhance frequency efficiency and improve system networks, and next-generation distributed computing technologies that utilize ultra-high-performance communication and computing resources to realize highly complex services beyond the limitations of UE computing capabilities.

### DISCLOSURE OF INVENTION

### Technical Problem

The present disclosure is directed to providing a method for efficiently performing and reporting measurements by configuring parameters based on an altitude of a terminal.

The technical problems to be achieved by embodiments of the present disclosure are not limited to the above-described technical problems. That is, other technical problems that are not described may be obviously understood by those skilled in the art to which the present disclosure pertains from the following description.

### Solution to Problem

According to an aspect of the present disclosure, a method performed by a terminal of a wireless communication system includes: acquiring, from a base station, measurement configuration information including altitude-related information; performing measurement on at least one cell for at least one altitude based on the altitude-related information; and reporting a measurement result for the at least one cell to the base station based on the altitude-related information, in which the altitude-related information includes at least one altitude threshold value for determining whether to trigger the reporting of the at least one measurement result. According to another aspect of the present disclosure, a method performed by a base station of a wireless communication system includes: transmitting, to a terminal, measurement configuration information including altitude-related information; and receiving, from the terminal, a measurement result for at least one cell measured based on the altitude-related information, in which the altitude-related information includes at least one altitude threshold value related to whether to trigger reporting of the at least one measurement result. According to yet another aspect of the present disclosure, a terminal of a wireless communication system includes: a transceiver configured to transmit and receive a signal; and a control unit, in which the control unit acquires, from a base station measurement configuration information including altitude-related information, performs measurement on at least one cell for at least one altitude based on the altitude-related information, reports a measurement result for the at least one cell to the base station based on the altitude-related information, and the altitude-related information includes at least one altitude threshold value for determining whether to trigger the reporting of the at least one measurement result. According to still another aspect of the present disclosure, a base station of a wireless communication system includes: a transceiver configured to transmit and receive a signal; and a control unit, in which the control unit transmits, to a terminal, measurement configuration information including altitude-related information, and receives, from the terminal, a measurement result for at least one cell measured based on the altitude-related information, and the altitude-related information includes at least one altitude threshold value related to whether to trigger reporting of the at least one measurement result.

### Advantageous Effects of Invention

According to an embodiment of the present disclosure, it is possible to efficiently perform and report measurements by configuring parameters based on an altitude of a terminal.

Effects which can be achieved by the present disclosure are not limited to the effects described in various embodiments. That is, other effects that are not mentioned may be obviously understood by those skilled in the art to which the present disclosure pertains from the following description.

### BRIEF DESCRIPTION OF DRAWINGS

FIG. 1A is a diagram illustrating the architecture of a long-term evolution (LTE) system according to an embodiment of the present disclosure.

FIG. 1B is a diagram illustrating the wireless protocol architecture of the long-term evolution (LTE) system according to an embodiment of the present disclosure.

FIG. 1C is a diagram illustrating the architecture of a next-generation mobile communication system according to an embodiment of the present disclosure.

FIG. 1D is a diagram illustrating the wireless protocol architecture of a next-generation mobile communication system according to an embodiment of the present disclosure.

FIG. 1E is a flowchart of a process in which an uncrewed aerial vehicle (UAV) terminal transmits an event-based measurement result message to a base station in the next-generation mobile communication system according to an embodiment of the present disclosure.

FIG. 1F is a flowchart of the process in which the uncrewed aerial vehicle (UAV) terminal transmits the event-based measurement result message to the base station in the next-generation mobile communication system according to an embodiment of the present disclosure.

FIG. 1G is a flowchart of the process in which the uncrewed aerial vehicle (UAV) terminal transmits the event-based measurement result message to the base station in the next-generation mobile communication system according to an embodiment of the present disclosure.

FIG. 1H is a flowchart of a process in which the uncrewed aerial vehicle (UAV) terminal efficiently reports a MeasurementReport to the base station in the next-generation mobile communication system according to an embodiment of the present disclosure.

FIG. 1I is a flowchart of the process in which the uncrewed aerial vehicle (UAV) terminal efficiently reports the MeasurementReport to the base station in the next-generation mobile communication system according to an embodiment of the present disclosure.

FIG. 1J is a flowchart of the process in which the uncrewed aerial vehicle (UAV) terminal efficiently reports the MeasurementReport to the base station in the next-generation mobile communication system according to an embodiment of the present disclosure.

FIG. 1K is a flowchart of the process in which the uncrewed aerial vehicle (UAV) terminal efficiently reports the MeasurementReport to the base station in the next-generation mobile communication system according to an embodiment of the present disclosure.

FIG. 1L is a block diagram illustrating an internal structure of a terminal according to an embodiment of the present disclosure.

FIG. 1M is a block diagram illustrating an internal structure of a base station according to an embodiment of the present disclosure.

### MODE FOR THE INVENTION

Hereinafter, an operation principle of the present disclosure will be described in detail with reference to the accompanying drawings. Further, when it is determined that the detailed description of the known art related to the present disclosure may obscure the gist of the present disclosure, the detailed description thereof will be omitted. Further, the following terms are defined in consideration of the functions in the present disclosure and may be construed in different ways by the intention or practice of users and operators. Therefore, the definitions thereof should be construed based on the contents throughout the specification. Further, when it is determined that the detailed description of the known art related to the present disclosure may obscure the gist of the present disclosure, the detailed description thereof will be omitted. Hereinafter, embodiments will be described with reference to the accompanying drawings.

In the following description, terms used to identify access nodes, terms referring to network entities, terms referring to messages, terms referring to interfaces between network entities, terms referring to various pieces of identification information, etc., are examples for convenience of description. Accordingly, the present disclosure is not limited to terms described below, and other terms referring to objects having equivalent technical meanings may be used.

For convenience of description, the present disclosure uses terms and names defined in the 3rd Generation Partnership Project Long Term Evolution (3GPP LTE) standard. However, the present disclosure is not limited to the terms and names, and may be equally applied to systems conforming to other standards. In the present disclosure, the term “eNB” may be used interchangeably with “gNB” for convenience of description. In other words, a base station described as an eNB may also represent a gNB.

In the present disclosure, it will be appreciated that each block of processing flowcharts and combinations of the flowcharts may be executed by computer program instructions. Since these computer program instructions may be mounted in a processor of a general computer, a special computer, or other programmable data processing apparatuses, these computer program instructions executed through the processor of the computer or the other programmable data processing apparatuses create means performing functions described in a block(s) of the flowchart. Since these computer program instructions may also be stored in a computer usable or computer readable memory that may be directed to a computer or other programmable data processing apparatuses in order to implement the functions in a specific scheme, the computer program instructions stored in the computer usable or computer readable memory can also produce manufacturing articles including instruction means performing the functions described in the block(s) of the flowchart. Since the computer program instructions may also be mounted on the computer or the other programmable data processing apparatuses, the instructions performing a series of operation steps on the computer or the other programmable data processing apparatuses to create processes executed by the computer, thereby executing the computer or the other programmable data processing apparatuses may also provide steps for performing the functions described in a block(s) of the flowchart.

In addition, each block may indicate some of modules, segments, or codes including one or more executable instructions for executing a specific logical function(s). Further, it is to be noted that functions mentioned in the blocks occur regardless of a sequence in some alternative embodiments. For example, two blocks that are continuously illustrated may be simultaneously performed in fact or be performed in a reverse sequence depending on corresponding functions.

In this case, the term ‘~unit’ used in the present embodiment means software or hardware components such as field programmable gate array (FPGA) or application specific integrated circuit (ASIC), and the ‘~unit’ performs certain roles. However, the ‘~unit’ is not meant to be limited to the software or hardware. The ‘~unit’ may be configured to be stored in a storage medium that can be addressed or may be configured to reproduce one or more processors. Accordingly, as an example, the ‘~unit’ includes to components such as software components, object-oriented software components, class components, and task components, processes, functions, attributes, procedures, subroutines, segments of program code, drivers, firmware, microcode, circuits, data, databases, data structures, tables, arrays and variables. Components and functions provided within ‘~unit’ may be combined into a smaller number of components and ‘~unit’ or may be further separated into additional components and ‘~unit.’ In addition, components and ‘~ units’ may be implemented to reproduce one or more CPUs in a device or a secure multimedia card. In addition, in an embodiment, the ‘~unit’ may include one or more processors.

In the present disclosure, each of phrases such as “A and/or B,” “A or B,” “at least one of A and B,” “at least one of A or B”, “B or C,” “at least one of B and C” and “at least one of B or C” may include any one of the items listed along with the corresponding phrase among these phrases, or any possible combination thereof. Terms such as “first,” “second,” “1^{st},” or “2^{nd}” may simply be used to distinguish the corresponding component from another component, and do not limit the corresponding components in other respects (e.g., importance or order).

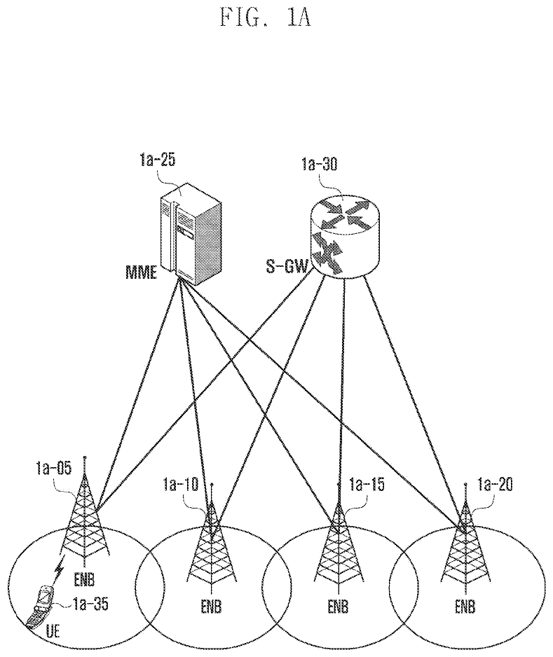

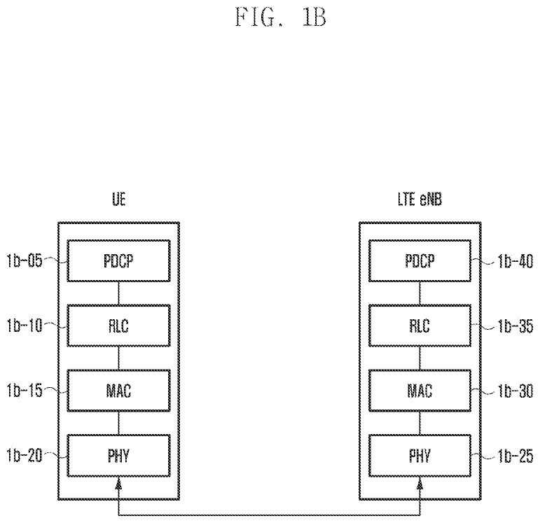

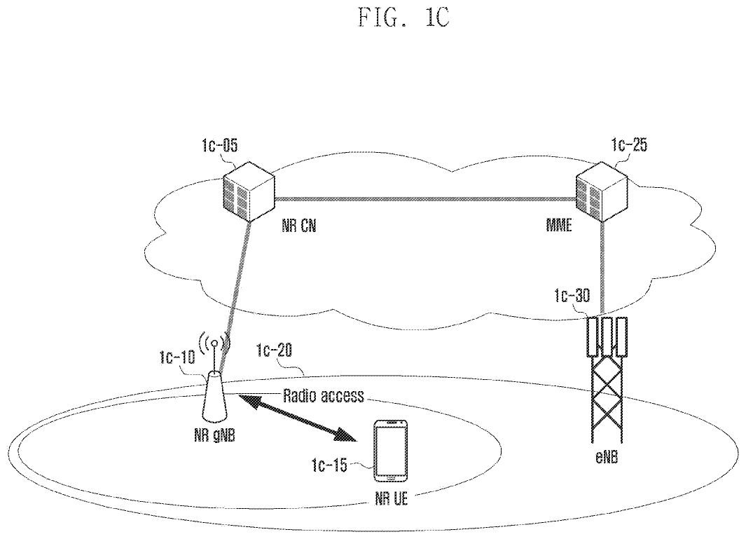

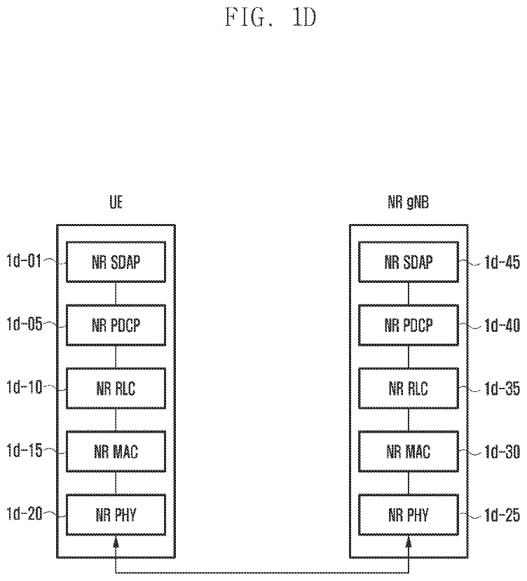

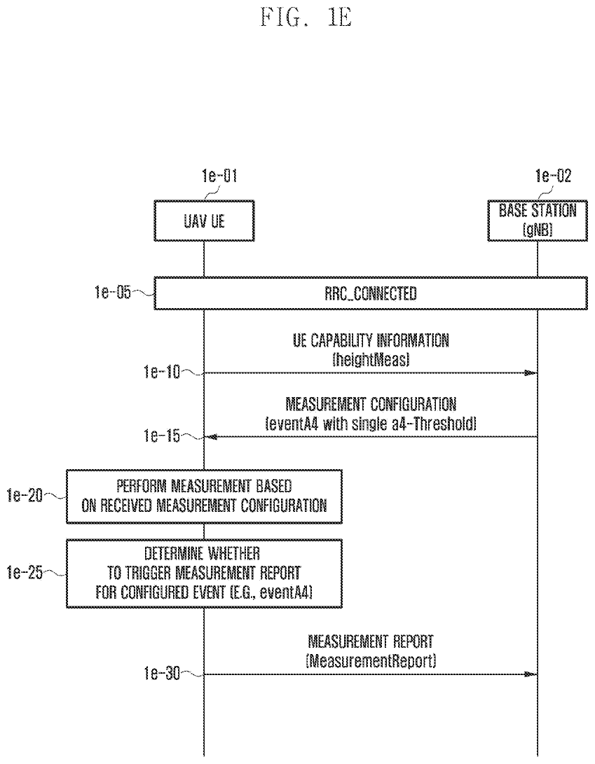

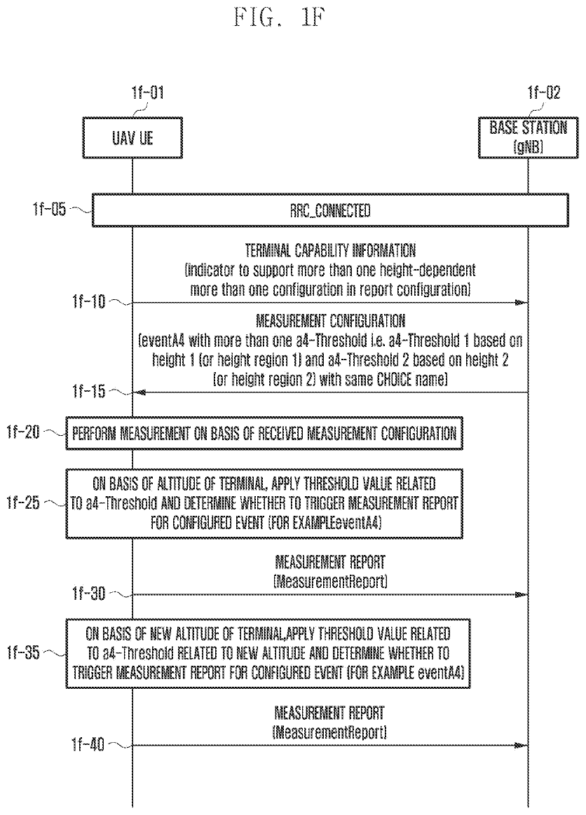

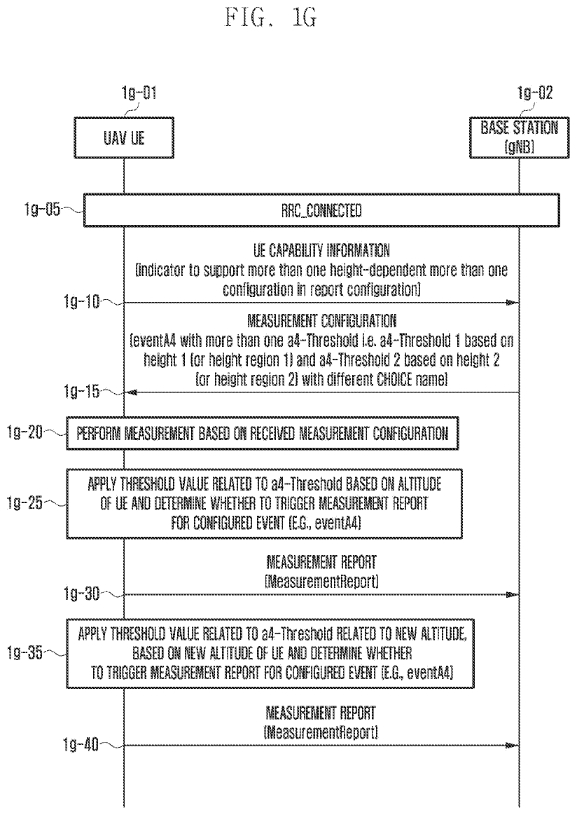

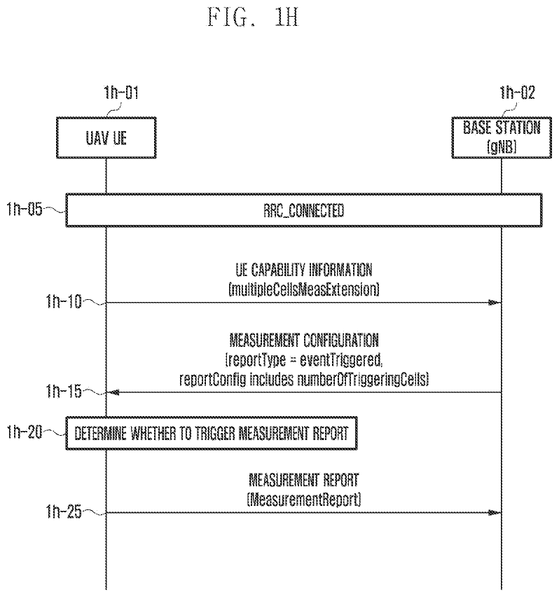

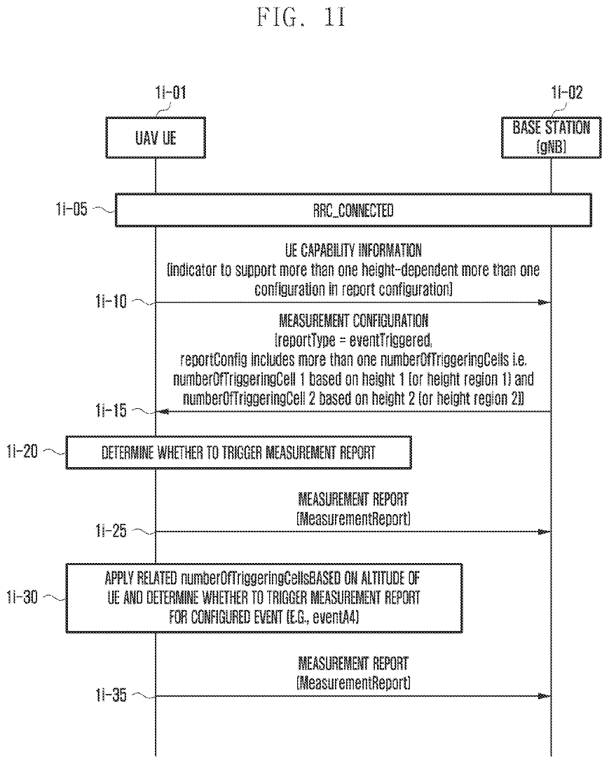

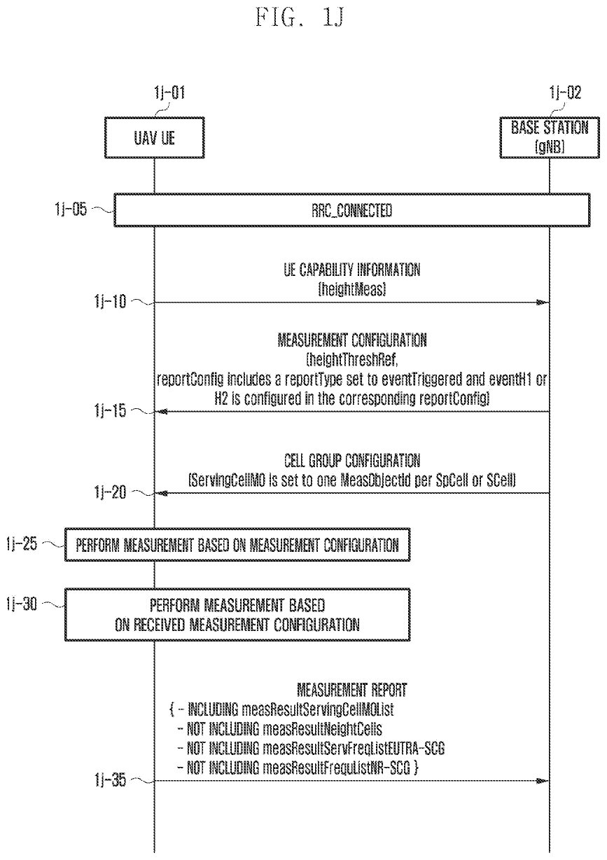

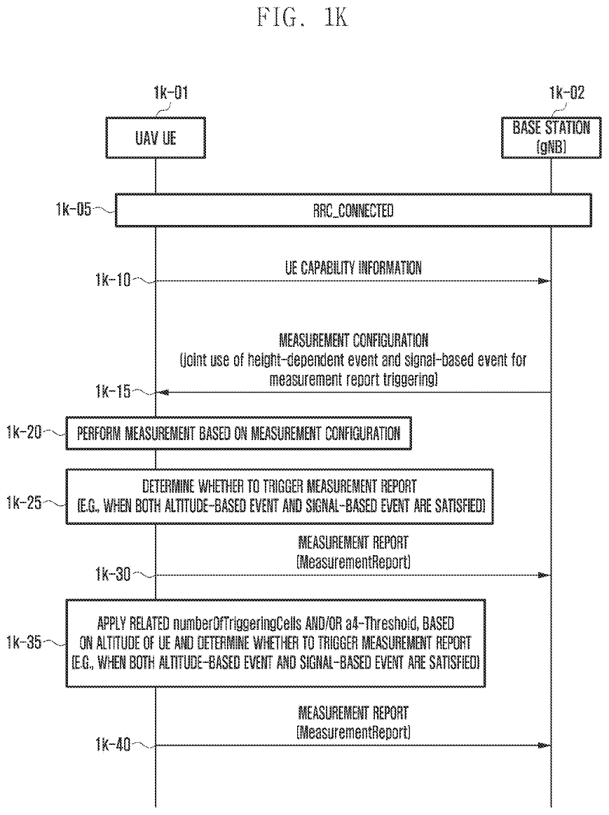

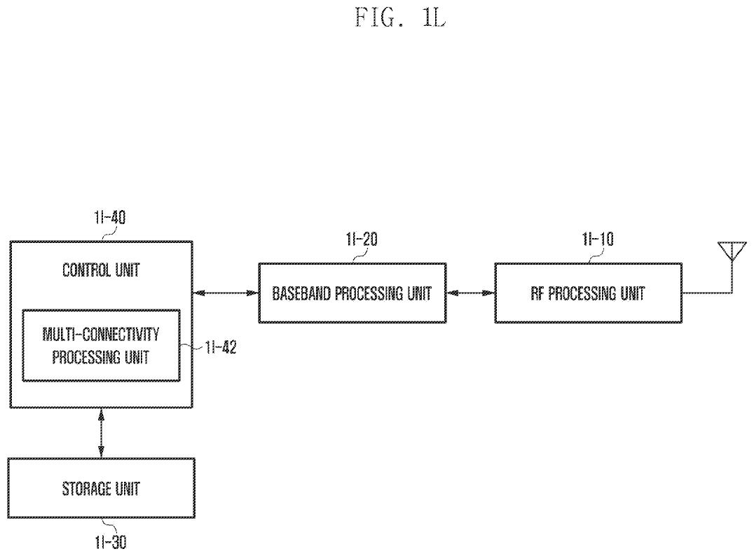

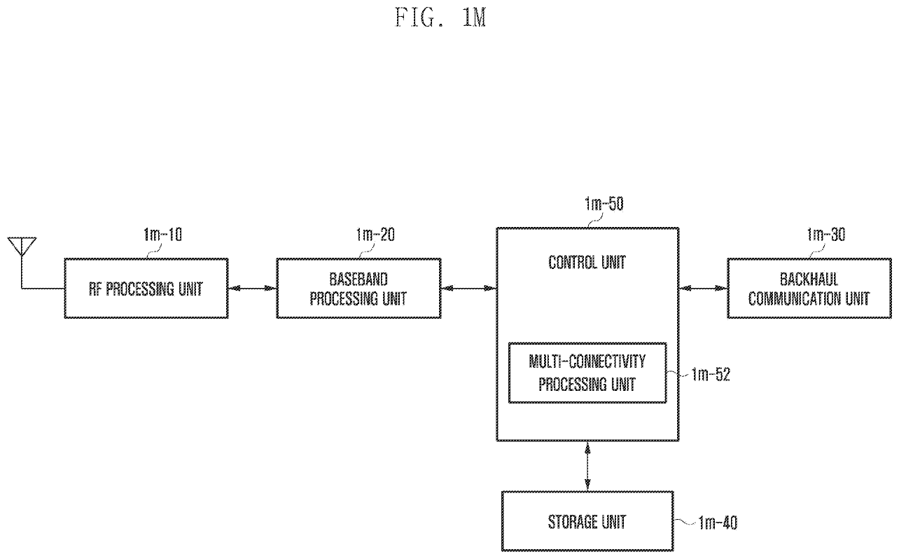

In the present disclosure, network technology may refer to standard specifications (e.g., TS 23.501, TS 23.502, TS 23.503, etc.) defined by the International Telecommunication Union (ITU) or 3GPP, and components included in network architecture of FIG. 1 to be described below may mean a physical entity, or may mean software performing an individual function, or hardware combined with software. Reference symbols shown as Nx, such as N1, N2, N3, . . . , in the drawings represent known interfaces between NFs in a 5G core network (CN). FIG. 1A is a diagram illustrating the architecture of a long-term evolution (LTE) system according to an embodiment of the present disclosure.

Referring to FIG. 1A, a radio access network of the LTE system is composed of next-generation base stations (evolved node B, hereinafter referred to as ENB, node B, or base station) 1a-05, 1a-10, 1a-15, and 1a-20, a mobility management entity (MME) 1a-25, and a serving gateway (S-GW) 1a-30. A user equipment (UE) (hereinafter, referred to as terminal) 1a-35 access an external network via the ENBs 1a-05 to 1a-20 and the S-GW 1a-30.

In FIG. 1A, the ENBs 1a-05, 1a-10, 1a-15, and 1a-20 correspond to the existing Node B in a UMTS system. The ENB is connected to a UE 1a-35 via the wireless channel and perform a more complex role than the existing Node B.

In the LTE system, all user traffic, including real-time services like voice over IP (VOIP) via the Internet protocol, is serviced through a shared channel. Therefore, there is a need for an apparatus that collects status information such as a buffer status, available transmit power status, and channel status of UEs for scheduling. The ENBs 1a-05, 1a-10, 1a-15, and 1a-20 are responsible for the scheduling function.

One ENB typically controls multiple cells. For example, to implement a transmission speed of 100 Mbps, the LTE system uses an orthogonal frequency division multiplexing (hereinafter, referred to as OFDM) scheme as a radio access technology in a 20 MHz bandwidth. In addition, an adaptive modulation & coding (hereinafter, referred to as AMC) scheme, which determines the modulation scheme and channel coding rate according to the channel status of the UE, is applied.

The S-GW 1a-30 is an apparatus that provides data bearers and creates or removes the data bearers under the control of the MME 1a-25. The MME is an apparatus that is responsible for various control functions as well as a mobility management function for a UE, and is connected to multiple base stations.

FIG. 1B is a diagram illustrating the wireless protocol architecture of the long-term evolution (LTE) system according to an embodiment of the present disclosure.

Referring to FIG. 1B, the wireless protocol of the LTE system is composed of packet data convergence protocols (PDCP) 1b-05 and 1b-40, radio link control (RLC) 1b-10 and 1b-35, and medium access control (MAC) 1b-15 and 1b-30 in the UE and ENB, respectively. The packet data convergence protocols (PDCP) 1b-05 and 1b-40 are responsible for operations such as IP header compression/reconstruction. The main functions of the PDCP are summarized as follows.
Header compression and decompression function (Header compression and decompression: ROHC only)
User data transfer function (Transfer of user data)
In-sequence delivery function (In-sequence delivery of upper layer PDUs at PDCP re-establishment procedure for RLC AM)
Reordering function (For split bearers in DC (only support for RLC AM): PDCP PDU routing for transmission and PDCP PDU reordering for reception)
Duplicate detection function (Duplicate detection of lower layer SDUs at PDCP re-establishment procedure for RLC AM)
Retransmission function (Retransmission of PDCP SDUs at handover and, for split bearers in DC, of PDCP PDUs at PDCP data-recovery procedure, for RLC AM)
Ciphering and deciphering function (Ciphering and deciphering)
Timer based SDU discard function (Timer-based SDU discard in uplink.)

Radio link control (hereinafter, referred to as RLC) 1b-10 and 1b-35 reconfigures a PDCP packet data unit (PDCP PDU) to an appropriate size and performs an ARQ operation, etc. The main functions of the RLC are summarized as follows.
Data transfer function (Transfer of upper layer PDUs)
ARQ function (Error Correction through ARQ (only for AM data transfer))
Concatenation, segmentation, reassembly function (Concatenation, segmentation and reassembly of RLC SDUs (only for UM and AM data transfer))
Re-segmentation function (Re-segmentation of RLC data PDUs (only for AM data transfer))
Reordering function (Reordering of RLC data PDUs (only for UM and AM data transfer))
Duplicate detection function (Duplicate detection (only for UM and AM data transfer))
Error detection function (Protocol error detection (only for AM data transfer))
RLC SDU discard function (RLC SDU discard (only for UM and AM data transfer))
RLC re-establishment function (RLC re-establishment)

MACs 1b-15 and 1b-30 are connected to multiple RLC layer entities configured in one UE, and multiplexes RLC PDUs into MAC PDUs and demultiplexes RLC PDUs from MAC PDUs. The main functions of MAC are summarized as follows.
Mapping function (Mapping between logical channels and transport channels)
Multiplexing and demultiplexing function (Multiplexing/demultiplexing of MAC SDUs belonging to one or different logical channels into/from transport blocks (TB) delivered to/from the physical layer on transport channels)
Scheduling information reporting function (Scheduling information reporting)
HARQ function (Error correction through HARQ)
Function for priority adjustment between logical channels (Priority handling between logical channels of one UE)
Function for priority adjustment between UEs (Priority handling between UEs by means of dynamic scheduling)
MBMS service identification function (MBMS service identification)
Transport format selection function (Transport format selection)
Padding function (Padding)

The physical layers 1b-20 and 1b-25 may perform operations of channel-coding and modulating higher layer data, converting the higher layer data into OFDM symbols for transmission via the wireless channel, or demodulating and channel-decoding the OFDM symbols received via the wireless channel and delivering the OFDM symbols to the higher layer.

FIG. 1C is a diagram illustrating the architecture of a next-generation mobile communication system according to an embodiment of the present disclosure. Referring to FIG. 1C, as illustrated, the radio access network of the next-generation mobile communication system (hereinafter referred to as NR or 2G) is composed of a next-generation base station (new radio node B, hereinafter referred to as NR gNB or NR base station) 1c-10 and an a new radio core network (NR CN) 1c-05. A user equipment (new radio user equipment, hereinafter referred to as NR UE or terminal) 1c-15 accesses an external network via the NR gNB 1c-10 and the NR CN 1c-05.

In FIG. 1C, the NR gNB 1c-10 corresponds to the evolved node B (eNB) of the existing LTE system. The NR gNB is connected to the NR UE 1c-15 via the wireless channel and may provide superior service compared to the existing node B. In the next-generation mobile communication system, all user traffic is serviced through the shared channel. Therefore, there is a need for the apparatus that collects status information such as the buffer status, available transmit power status, and channel status of the UEs for scheduling. The scheduling function is handled by the NR NB 1c-10.

One NR gNB typically controls multiple cells. In order to realize ultra-high-speed data transmission compared to the current LTE system, a bandwidth greater than or equal to the existing maximum bandwidth may be supported, and beamforming technology may be additionally applied in which Orthogonal Frequency Division Multiplexing (OFDM) is employed as a radio access technology. In addition, the adaptive modulation & coding (hereinafter, referred to as AMC) scheme, which determines the modulation scheme and channel coding rate according to the channel status of the UE, is applied.

The NR CN 1c-05 performs functions such as mobility support, bearer configuration, and QoS configuration. The NR CN is an apparatus that is responsible for various control functions as well as the mobility management function for the UE, and is connected to multiple base stations. In addition, the next-generation mobile communication system may also be interoperated with the existing LTE system, and the NR CN is connected to the MME 1c-25 via the network interface. The MME is connected to the eNB 1c-30 that is the existing base station.

FIG. 1D is a diagram illustrating the wireless protocol architecture of a next-generation mobile communication system according to an embodiment of the present disclosure.

Referring to FIG. 1D, the wireless protocol of the next-generation mobile communication system is composed of NR service data adaptation protocols (NR SDAP) 1d-01 and 1d-45, NR packet data convergence protocols (NR PDCP) 1d-05 and 1d-40, NR radio link control (NR RLC) 1d-10 and 1d-35, and NR medium access control (NR MAC) 1d-15 and 1d-30 at the UE and the NR base station, respectively.

The main functions of the NR SDAP 1d-01 and 1d-45 may include some of the following functions.
Transfer function of user data (transfer of user plane data)
Mapping function of QoS flow and data bearer with respect to uplink and downlink (mapping between a QoS flow and a DRB for both DL and UL)
Marking function of QoS flow ID with respect to uplink and downlink (Marking of QoS flow ID in both DL and UL packets)
Function of mapping reflective QoS flow to data bearer with respect to uplink SDAP PDUs (reflective QoS flow to DRB mapping for the UL SDAP PDUs). For the SDAP layer entity, the UE may be configured to determine, via an RRC message, whether to use a header of the SDAP layer entity or a function of the SDAP layer entity on a per-PDCP layer entity basis, per-bearer basis, or per-logical channel basis. When the SDAP header is configured, the UE may be instructed by a 1-bit indicator for NAS reflection QoS configuration (NAS reflective QoS) and a 1-bit indicator for AS reflection QoS configuration (AS relective Qos) of the SDAP header to update or reconfigure the mapping information for the QoS flow and data bearer in the uplink and downlink. The SDAP header may include QoS flow ID information representing QoS. The QoS information may be used as data processing priority, scheduling information, etc., to support smooth service.

The main functions of the NR PDCP 1d-05 and 1d-40 may include some of the following functions.
Header compression and decompression function (Header compression and decompression: ROHC only)
User data transfer function (Transfer of user data)
In-sequence delivery function (In-sequence delivery of upper layer PDUs)
Out-of-sequence delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer based SDU discard function (Timer-based SDU discard in uplink.)

The reordering function of the NR PDCP entity described above refers to the function of reordering PDCP PDUs received from a lower layer in sequence based on the PDCP sequence number (SN), and may include a function of delivering data to the higher layer in the reordered order, or a function of directly delivering PDCP PDUs without considering order, a function of recording lost PDCP PDUs by reordering, a function of reporting a status of lost PDCP PDUs to a transmitting side, and a function of requesting retransmission of lost PDCP PDUs.

The main functions of the NR RLC 1d-10 and 1d-35 may include some of the following functions.
Data transfer function (Transfer of upper layer PDUs)
In-sequence delivery function (In-sequence delivery of upper layer PDUs)
Out-of-sequence delivery function (Out-of-sequence delivery of upper layer PDUs)
ARQ function (Error correction through ARQ)
Concatenation, segmentation, reassembly function (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

The in-sequence delivery function of the NR RLC entity refers to the function of sequentially delivering RLC SDUs received from the lower layer to the higher layer. The in-sequence delivery function of the NR RLC entity may include a function of, when an original one RLC SDU is received after being segmented into multiple RLC SDUs, reassembling and delivering the RLC SDUs, a function of reordering the received RLC PDUs based on the RLC sequence number (SN) or the PDCP sequence number (SN), a function of recording lost RLC PDUs by reordering the RLC PDUs, a function of reporting a status of lost RLC PDUs to a transmitting side, and a function of requesting retransmission of the lost RLC PDUs. The in-sequence delivery function of the NR RLC entity may include a function of delivering, to the higher layer in sequence only the RLC SDUs before the lost RLC SDU when there is the lost RLC SDU, or a function of delivering, to the higher layer, in sequence all RLC SDUs received before a timer runs when a predetermined timer has expired even when there are the lost RLC SDUs, or may include a function of delivering in sequence all RLC SDUs received so far to the higher layer when the predetermined timer has expired even when there are the lost RLC SDUs. In addition, the RLC PDUs may be processed in the sequence they are received (in the sequence of arrival, regardless of the sequence of the sequence number) and delivered to the PDCP entity out-of sequence. In the case of the segment, the segments stored in the buffer or to be received later may be received, reconstructed into one complete RLC PDU, processed, and then delivered to the PDCP entity. The NR RLC layer may not include a concatenation function, and the function may be performed in the NR MAC layer or replaced with a multiplexing function of the NR MAC layer.

The out-of-sequence delivery function of the NR RLC entity described above refers to the function of directly delivering the RLC SDUs received from the lower layer to the higher layer out-of-sequence. When the original one RLC SDU is segmented into multiple RLC SDUs and received, the out-of-sequence delivery function may include a function of reassembling and delivering multiple RLC SDUs, and include a function of storing the RLC SNs or PDCP SNs of the received RLC PDUs, ordering the RLC SNs or PDCP SNs, and recording the lost RLC PDUs.

The NR MAC 1d-15 and 1d-30 may be connected to multiple NR RLC layer entities configured in one UE, and the main functions of the NR MAC may include some of the following functions.
Mapping function (Mapping between logical channels and transport channels)
Multiplexing and demultiplexing function (Multiplexing/demultiplexing of MAC SDUs)
Scheduling information reporting function (Scheduling information reporting)
HARQ function (Error correction through HARQ)
Function for priority adjustment between logical channels (Priority handling between logical channels of one UE)
Function for priority adjustment between UEs (Priority handling between UEs by means of dynamic scheduling)
MBMS service identification function (MBMS service identification)
Transport format selection function (Transport format selection)
Padding function (Padding)

The NR PHY layer 1d-20 and 1d-25 may perform operations such as channel coding and modulating higher layer data, converting the higher layer data into OFDM symbols to transmit via a wireless channel, or demodulating and channel decoding the OFDM symbols received via the wireless channel and delivering the OFDM symbols to the higher layer.

FIG. 1E is a flowchart of a process in which an uncrewed aerial vehicle (UAV) UE transmits an event-based measurement result message to a base station in the next-generation mobile communication system according to an embodiment of the present disclosure.

An uncrewed aerial vehicle (UAV) UE may refer to a UE capable of flight. Therefore, the UAV UE may have a higher probability of line-of-sight than a terrestrial UE.

Therefore, the UAV UE may have the disadvantage of receiving downlink (hereinafter, referred to as DL) interference from more cells than the terrestrial UE. That is, the UAV UE has the characteristic of receiving a higher level of DL interference from more neighbour cells than the terrestrial UE. Similarly, the UAV UE has the characteristics of causing uplink (hereinafter, referred to as UL) interference to more cells than the terrestrial UE.

The present disclosure proposes a method for reporting a MeasurementReport to a base station according to the above-described UAV UE characteristics.

Referring to FIG. 1B, in step 1e-05, a UAV UE 1e-01 may establish a radio resource control (RRC) connection with an NR base station (gNB) 1e-02 and may be in an RRC connected mode (RRC_CONNECTED).

In step 1e-10, the UAV UE 1e-01 may report the UE capability to the base station 1e-02.

For example, the UAV UE 1e-01 may transmit a UE capability information message (UECapability Information) to the base station 1e-02. The UE capability information message may include an indicator (heightMeas) indicating whether the UE supports Event H1/H2

In step 1e-15, the base station 1e-02 may transmit a predetermined RRC message (e.g., RRCReconfiguration) containing measurement configuration information (MeasConfig) to the UAV UE 1e-01.

For example, the measurement configuration information (MeasConfig) may include measurement object configuration information (MeasObjectToAddModList) for objects on which the UE 1e-01 performs measurement, report configuration information (ReportConfigToAddModList), measurement identifier configuration information (MeasIdToAddModList) that identifies a measurement configuration by connecting one reporting configuration and one measurement object configuration information, measurement quantity configuration information (QuantityConfig) that contains measurement quantities and layer 3 filtering coefficients for measurement, etc.

The MeasConfig may have an abstract syntax notation number one (ASN.1) structure as described below.

| | |
|---|---|
| MeasConfig ::= | SEQUENCE { |

| | |
|---|---|
| measObjectToRemoveList | MeasObjectToRemoveList |

OPTIONAL, [symbol] Need N

| | |
|---|---|
| measObjectToAddModList | MeasObjectToAddModList |

OPTIONAL, [symbol] Need N

| | |
|---|---|
| reportConfigToRemoveList | ReportConfigToRemoveList |

OPTIONAL, [symbol] Need N

| | |
|---|---|
| reportConfigToAddModList | ReportConfigToAddModList |

OPTIONAL, [symbol] Need N

| | |
|---|---|
| measIdToRemoveList | MeasIdToRemoveList |

OPTIONAL, [symbol] Need N

| | |
|---|---|
| measIdToAddModList | MeasIdToAddModList |

OPTIONAL, [symbol] Need N

| | |
|---|---|
| s-MeasureConfig | CHOICE { |
| ssb-RSRP | RSRP-Range, |
| csi-RSRP | RSRP-Range |

}
OPTIONAL, [symbol] Need M

| | |
|---|---|
| quantityConfig | QuantityConfig |

OPTIONAL, [symbol] Need M

| | |
|---|---|
| measGapConfig | MeasGapConfig |

OPTIONAL, [symbol] Need M

| | |
|---|---|
| measGapSharingConfig | MeasGapSharingConfig |

```
OPTIONAL, [symbol]  Need M
  ...,
  [[
```

| | |
|---|---|
| interFrequencyConfig-NoGap-r16 | ENUMERATED [symbol] true [symbol] |

OPTIONAL, [symbol] Need R
]]

[symbol]

[symbol]

indicates data missing or illegible when filed

The MeasObjectToAddModList may MeasObjectNR, and the MeasObjectNR may have an ASN.1 structure as described below.

| | |
|---|---|
| MeasObjectNR ::= | SEQUENCE { |

| | |
|---|---|
| ssbFrequency | ARFCN-ValueNR |

OPTIONAL, [symbol] Cond [symbol] SSB

| | |
|---|---|
| ssbSubcarrierSpacing | SubcarrierSpacing |

OPTIONAL, [symbol] Cond [symbol] SSB

| | |
|---|---|
| sm [symbol] 1 | SSB-MTC |

OPTIONAL, [symbol] Cond [symbol] SSB

| | |
|---|---|
| sm [symbol] 2 | SSB-MTC2 |

OPTIONAL, [symbol] Cond [symbol] Connected

| | |
|---|---|
| refFreqCSI-RS | AR [symbol] N [symbol] ValueNR |

OPTIONAL, [symbol] Cond

[symbol]

| | |
|---|---|
| referenceSignalConfig | ReferenceSignalConfig, |

| | |
|---|---|
| absThreshSS-BlocksConsolidation | ThresholdNR |

OPTIONAL, [symbol] Need R

| | |
|---|---|
| absThreshCSI-RS-Consolidation | ThresholdNR |

OPTIONAL, [symbol] Need R

| | |
|---|---|
| nrofSS-BlocksToAverage | INTEGER (2..maxNrof [symbol] -BlocksToAverage) |

OPTIONAL, [symbol] Need R

| | |
|---|---|
| nrofCSI-RS-ResourcesToAverage | INTEGER (2..maxNrofCSI-RS-ResourcesToAverage) |

OPTIONAL, [symbol] Need R

| | |
|---|---|
| quantityConfigIndex | INTEGER (1..maxNrofQuantityConfig), |
| offsetMO | Q-OffsetRangeList, |

| | |
|---|---|
| cellsToRemoveList | PCI-List |

OPTIONAL, [symbol] Need N

| | |
|---|---|
| cellsToAddModList | CellsToAddModList |

OPTIONAL, [symbol] Need N

| | |
|---|---|
| excludedCellsToRemoveList | PCI-RangeIndexList |

OPTIONAL, [symbol] Need N

| | |
|---|---|
| excludedCellsToAddModList | SEQUENCE (SIZE (1..maxNrofPCI-Ranges)) OF PCI- |

| | |
|---|---|
| RangeElement | OPTIONAL, [symbol] Need N |

| | |
|---|---|
| allowedCellsToRemoveList | PCI-RangeIndexList |

OPTIONAL, [symbol] Need N

| | |
|---|---|
| allowedCellsToAddModList | SEQUENCE (SIZE (1..maxNrofPCI-Ranges)) OF PCI- |

| | |
|---|---|
| RangeElement | OPTIONAL, [symbol] Need N |

```
    ...,
    [[
```

| | |
|---|---|
| freqBandIndicato [symbol] NR | FreqBandIndicatorNR |

OPTIONAL, [symbol] Need R

| | |
|---|---|
| measCycleSCell | ENUMERATED {sf160, [symbol] 256, [symbol] 320, [symbol] 512, sf640 |

| | |
|---|---|
| sf1024, sf1280} | OPTIONAL, [symbol] Need R |

```
    ]],
    [[
```

| | |
|---|---|
| smtc3list-r16 | SSB-MTC3List-r16 |

OPTIONAL, [symbol] Need R

| | |
|---|---|
| rmtc-Config-r16 | SetupRelease {RMTC-Config-r16} |

OPTIONAL, [symbol] Need M

| | |
|---|---|
| [symbol] -r16 | SetupRelease { T312-r16 } |

```
OPTIONAL, [symbol]  Need M
    ]],
    [[
```

| | |
|---|---|
| associatedMeasGapSSB-r17 | MeasGapId-r17 |

OPTIONAL, [symbol] Need R

| | |
|---|---|
| associatedMeasGap [symbol] SIRS-r17 | MeasGapId-r17 |

OPTIONAL, [symbol] Need R

| | |
|---|---|
| smtc4list-r17 | SSB-MTC4List-r17 |

OPTIONAL, [symbol] Need R

| | |
|---|---|
| measCyclePSCell-r17 | ENUMERATED {ms160, ms256, ms320, ms512, ms640, |

ms1024, ms1280, spare1}
OPTIONAL, [symbol] Cond SCG

| | |
|---|---|
| cellsToAddModListExt-v1710 | CellsToAddModListExt-v1710 |

```
OPTIONAL, [symbol]  Need N
  ]],
  [[
```

| | |
|---|---|
| associatedMeasGapSSB2-v1720 | MeasGapId-r17 |

OPTIONAL, [symbol] Cond Associated [symbol] S [symbol] B

| | |
|---|---|
| associatedMeasGap [symbol] SIRS2-v1720 | MeasGapId-r17 |

OPTIONAL, [symbol] Cond Associated [symbol] SIRS
]]
}

| | |
|---|---|
| SSB-MTC3List-r16::= | SEQUENCE (SIZE(1..4)) OF SSB-MTC3-r16 |
| SSB-MTC4List-r17::= | SEQUENCE (SIZE(1..3)) OF SSB-MTC4-r17 |

| | |
|---|---|
| T312-r16 ::= | ENUMERATED {ms0, ms50, ms100, ms200, ms300, ms400, |

ms500, ms1000}

| | |
|---|---|
| ReferenceSignalConfig::= | SEQUENCE { |

| | |
|---|---|
| ssb-ConfigMobility | SSB-ConfigMobility |

OPTIONAL, [symbol] Need M

| | |
|---|---|
| csi- [symbol] -ResourceConfigMobility | SetupRelease { CSI-RS-ResourceConfigMobility } |

OPTIONAL, [symbol] Need M
}

| | |
|---|---|
| SSB-ConfigMobility::= | SEQUENCE { |

| | |
|---|---|
| ssb-ToMeasure | SetupRelease { SSB-ToMeasure } |

OPTIONAL, [symbol] Need M

| | |
|---|---|
| deriveSSB-IndexFromCell | BOOLEAN, |

| | |
|---|---|
| ss-RSSI-Measurement | SS-RSSI-Measurement |

```
OPTIONAL, [symbol]  Need M
    ...,
    [[
```

| | |
|---|---|
| ssb-PositionQCL-Common-r16 | SSB-PositionQCL-Relation-r16 |

OPTIONAL, [symbol] C [symbol] Spectrum

| | |
|---|---|
| ssb-PositionQCL-CellsToAddModList-r16 | SSB-PositionQCL-CellsToAddModList-r16 |

OPTIONAL, [symbol] Need N

| | |
|---|---|
| ssb-PositionQCL-CellsToRemoveList-r16 | PCI-List |

```
OPTIONAL, [symbol]  Need N
    ]],
    [[
```

| | |
|---|---|
| deriveSSB-IndexFromCellInter-r17 | ServCellIndex |

OPTIONAL, [symbol] Need R

| | |
|---|---|
| ssb-PositionQCL-Common-r17 | SSB-PostionQCL-Relation-r17 |

OPTIONAL, [symbol] C [symbol] Spectrum

[symbol]

| | |
|---|---|
| ssb-PositionQCL-Cells- [symbol] 17 | SetupRelease [symbol] SSB-PositionQCL-CellList- [symbol] 17 [symbol] |

```
OPTIONAL, [symbol]  Need M
    ]],
    [[
```

| | |
|---|---|
| [symbol] -CellsToAddModList-r17 | PCI-List |

OPTIONAL, [symbol] Need N

| | |
|---|---|
| cc [symbol] -CellsToRemoveList-r17 | PCI-List |

OPTIONAL, [symbol] Need N
]]
{

| Q-OffsetRangeList ::= | SEQUENCE { | |
|---|---|---|
| [symbol] pOffsetSSB | Q-OffsetRange | DEFAULT dB0, |
| [symbol] OffsetSSB | Q-OffsetRange | DEFAULT dB0, |
| [symbol] OffsetSSB | Q-OffsetRange | DEFAULT dB0, |
| [symbol] OffsetCSI-RS | Q-OffsetRange | DEFAULT dB0, |
| [symbol] OffsetCSI-RS | Q-OffsetRange | DEFAULT dB0, |
| [symbol] OffsetCSI-RS | Q-OffsetRange | DEFAULT dB0 |

}

| | |
|---|---|
| ThresholdNR ::= | SEQUENCE { |

| | |
|---|---|
| thresholdRSRP | RSRP-Range |

OPTIONAL, [symbol] Need R

| | |
|---|---|
| thresholdRSRQ | RSRQ-Range |

OPTIONAL, [symbol] Need

[symbol]

| | |
|---|---|
| thresholdSINR | SINR-Range |

OPTIONAL, [symbol] Need R
}

| | |
|---|---|
| CellsToAddModList ::= | SEQUENCE (SIZE (1..maxNrofCellMeas)) OF |

CellsToAddMod

| | |
|---|---|
| CellsToAddModListExt-v1710 ::= | SEQUENCE (SIZE (1..maxNrofCellMeas)) OF |

CellsToAddModList-v1710

| | |
|---|---|
| CellsToAddMod ::= | SEQUENCE { |
| physCellId | PhysCellId, |
| cellIndividualOffset | Q-OffsetRangeList |

}

| | |
|---|---|
| CellsToAddModExt-v1710 ::= | SEQUENCE { |

| | |
|---|---|
| [symbol] -PolarizationDL-r17 | ENUMERATED [symbol] linear [symbol] |

OPTIONAL, [symbol] Need R

| | |
|---|---|
| [symbol] -PolarizationUL-r17 | ENUMERATED [symbol] linear [symbol] |

OPTIONAL, [symbol] Need R

[symbol]

| | |
|---|---|
| RMTC-Config-r16 ::= | SEQUENCE { |

| | |
|---|---|
| [symbol] -Periodicity-r16 | ENUMERATED {ms40, ms80, ms160, ms320, ms640}, |
| [symbol] -SubframeOffset-r16 | INTEGER(0.639) |

OPTIONAL, [symbol] Need M

| | |
|---|---|
| measDurationSymbols-r16 | ENUMERATED {sym1, sym14or12, sym28or24, |

sym42or36, sym70or60}

[symbol]

| | |
|---|---|
| [symbol] -Frequency-r16 | ARF [symbol] N-ValueNR, |

| | |
|---|---|
| ref-SCS-CP-r16 | ENUMERATED {kHz15, kHz30, kHz60-NCP, kHz60- |

```

[symbol]
,
    ...,
    [[
```

| | |
|---|---|
| [symbol] -Bandwidth-r17 | ENUMERATED [symbol] mhz100, mhz400, mhz800, mhz1600, |

| | |
|---|---|
| mhz2000} | OPTIONAL, [symbol] Need R |

| | |
|---|---|
| measDurationSymbols-v1700 | ENUMERATED [symbol] sym140, sym560, sym1120} |

OPTIONAL, [symbol] Need R

| | |
|---|---|
| ref-SCS-CP-v1700 | ENUMERATED {kHz120, kHz480, kHz960} |

OPTIONAL, [symbol] Need R

| | |
|---|---|
| [symbol] -StateInfo-r17 | SEQUENCE { |
| [symbol] -StateId-r17 | TCI-StateId, |

| | |
|---|---|
| ref-ServCellId-r17 | ServCellIndex |

```
OPTIONAL, [symbol]  Need R
    } OPTIONAL, [symbol]  Need R
    ]],
    [[
```

| | |
|---|---|
| ref-BWPId-r17 | BWP-Id |

OPTIONAL, [symbol] Need R
]]
}

| | |
|---|---|
| SSB-PositionQCL-CellsToAddModList-r16 ::= | SEQUENCE (SIZE (1..maxNrofCellMeas)) OF SSB- |

PositionQCL-CellsToAddMod-r16

| | |
|---|---|
| SSB-PositionQCL- | SEQUENCE { |
| CellsToAddMod-r16 ::= | |
| physCellId-r16 | PhysCellId, |
| ssb-PositionQCL-r16 | SSB-PositionQCL-Relation-r16 |

}

| | |
|---|---|
| SSB-PositionQCL-CellList-r17 ::= | SEQUENCE (SIZE (1..maxNrofCellMeas)) OF SSB-PositionQCL- |

Cell-r17

| | |
|---|---|
| SSB-PositionQCL-Cell-r17 | ::= SEQUENCE { |
| physCellId-r17 | PhysCellId, |
| ssb-PositionQCL-r17 | SSB-PositionQCL-Relation-r17 |

} [symbol]
indicates data missing or illegible when filed

The ReportConfigToAddModList may store ReportConfigNR, and the ReportConfigNR may have an ASN.1 structure as described below.

For convenience of description, the present disclosure will be described on the basis that the reportType of ReportConfigNR is configured to eventTriggered and eventId of EventTriggerConfig stored in eventTriggered is configured to eventA4. However, this is for convenience of description and is not intended to limit the scope of the present disclosure. For example, the following description may be equally applied to other event conditions (e.g., eventA3, condEventA3, condEventA4, eventA5, condEventA5).

Event A4 refers to an event in which a neighbour cell becomes better than a threshold value. Specific contents thereof may be as follows. For reference, in the present disclosure, a single a4-Threshold may be configured for the Event A4, and the MeasTriggerQuantity configured for the a4-Threshold may include one of rsrp (RSRP-Range), rsrq (RSRQ-Range), and sinr (SINR-Range). 5.5.4.5 Event A4 (Neighbour becomes better than threshold) The UE shall:
1> consider the entering condition for this event to be satisfied when condition A4-1, as specified below, is fulfilled;
1> consider the leaving condition for this event to be satisfied when condition A4-2, as specified below, is fulfilled.

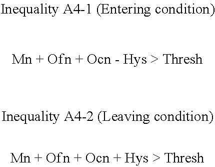

The variables in the formula are defined as follows:

Mn is the measurement result of the neighbouring cell, not taking into account any offsets.

Ofn is the measurement object specific offset of the neighbour cell (i.e., offsetMO as defined within measObjectNR corresponding to the neighbour cell).

Ocn is the measurement object specific offset of the neighbour cell (i.e., cellIndividualOffset as defined within measObjectNR corresponding to the neighbour cell), and set to zero if not configured for the neighbour cell.

Hys is the hysteresis parameter for this event (i.e., hysteresis as defined within reportConfigNR for this event).

Thresh is the threshold parameter for this event (i.e., a4-Threshold as defined within reportConfigNR for this event).

Mn is expressed in dBm in case of RSRP, or in dB in case of RSRQ and RS-SINR.

Ofn, Ocn, Hys are expressed in dB.

Thresh is expressed in the same unit as Mn.

NOTE: The definition of Event A4 also applies to CondEvent A4. In step 1e-20, the UE 1e-01 may perform the measurement based on the measurement configuration information received in step 1e-15. (Preform measurements based on the received MeasConfig)

In this case, a method for performing, by the UE 1e-01, Layer 3 filtering is as follows.

### 5.5.3.2 Layer 3 Filtering

The UE shall:
1> for each cell measurement quantity, each beam measurement quantity, each sidelink measurement quantity as needed in clause 5.8.10, for each CLI measurement quantity that the UE performs measurements according to 5.5.3.1, and for each candidate L2 U2N Relay UE measurement quantity according to 5.5.3.4:
   2> filter the measured result, before using for evaluation of reporting criteria or for measurement reporting, by the following formula:

$${F}_{n} = ( 1 - a ) * {F}_{n - 1} + a * {M}_{n}$$

where
Mₙ is the latest received measurement result from the physical layer;
Fₙ is the updated filtered measurement result, that is used for evaluation of reporting criteria or for measurement reporting;
Fₙ₋₁ is the old filtered measurement result, where F₀ is set to M₁ when the first measurement result from the physical layer is received; and for MeasObjectNR, a=½^{(ki/4)}, where kᵢ is the filterCoefficient for the corresponding measurement quantity of the i: th Quantity ConfigNR in quantity ConfigNR-List, and i is indicated by quantityConfigIndex in MeasObjectNR; for other measurements, a=½^{(k/4)}, where k is the filterCoefficient for the corresponding measurement quantity received by the quantityConfig; for UTRA-FDD, a=½^{(k/4)} where k is the filterCoefficient for the corresponding measurement quantity received by quantityConfigUTRA-FDD in the QuantityConfig;
   2> adapt the filter such that the time characteristics of the filter are preserved at different input rates, observing that the filterCoefficient k assumes a sample rate equal to X ms; The value of X is equivalent to one intra-frequency L1 measurement period as defined in TS 38.133 assuming non-DRX operation, and depends on frequency range.

The UE 1e-01 may derive Later 3 filtered cell measurement results and Layer 3 filtered beam measurement results, respectively, according to the following procedures.

### 5.5.3.3 Derivation of Cell Measurement Results

The network may configure the UE in RRC CONNECTED to derive RSRP, RSRQ and SINR measurement results per cell associated to NR measurement objects based on parameters configured in the measObject (e.g., maximum number of beams to be averaged and beam consolidation thresholds) and in the reportConfig (rsType to be measured, SS/PBCH block or CSI-RS).

The UE shall:
1> for each cell measurement quantity to be derived based on SS/PBCH block:
   2> if nrofSS-BlocksToAverage is not configured in the associated measObject in RRC_CONNECTED or in the associated entry in measIdleCarrierListNR within VarMeasIdleConfig in RRC_IDLE/RRC_INACTIVE; or
   2> if absThreshSS-BlocksConsolidation is not configured in the associated measObject in RRC_CONNECTED or in the associated entry in measIdleCarrierListNR within in VarMeasIdleConfig RRC_IDLE/RRC_INACTIVE; or
   2> if the highest beam measurement quantity value is below or equal to absThreshSS-BlocksConsolidation:
      3> derive each cell measurement quantity based on SS/PBCH block as the highest beam measurement quantity value, where each beam measurement quantity is described in TS 38.215 [9];
   2> else:
      3> derive each cell measurement quantity based on SS/PBCH block as the linear power scale average of the highest beam measurement quantity values above absThreshSS-BlocksConsolidation where the total number of averaged beams shall not exceed nrofSS-BlocksToAverage, and where each beam measurement quantity is described in TS 38.215 [9];
   2> if in RRC CONNECTED, apply layer 3 cell filtering as described in 5.5.3.2;
1> for each cell measurement quantity to be derived based on CSI-RS:
   2> consider a CSI-RS resource to be applicable for deriving cell measurements when the concerned CSI-RS resource is included in the csi-rs-CellMobility including the physCellId of the cell in theCSI-RS-ResourceConfigMobility in the associated measObject;
   2> if nrofCSI-RS-ResourcesToAverage in the associated measObject is not configured; or
   2> if absThreshCSI-RS-Consolidation in the associated measObject is not configured; or
   2> if the highest beam measurement quantity value is below or equal to absThreshCSI-RS-Consolidation:
      3> derive each cell measurement quantity based on applicable CSI-RS resources for the cell as the highest beam measurement quantity value, where each beam measurement quantity is described in TS 38.215 [9];
   2> else:
      3> derive each cell measurement quantity based on CSI-RS as the linear power scale average of the highest beam measurement quantity values above absThreshCSI-RS-Consolidation where the total number of averaged beams shall not exceed nrofCSI-RS-Resources ToAverage;
   2> apply layer 3 cell filtering as described in 5.5.3.2.

### 5.5.3.3a Derivation of Layer 3 Beam Filtered Measurement

The UE shall:
1> for each layer 3 beam filtered measurement quantity to be derived based on SS/PBCH block;
   2> derive each configured beam measurement quantity based on SS/PBCH block as described in TS 38.215 [9], and apply layer 3 beam filtering as described in 5.5.3.2;
1> for each layer 3 beam filtered measurement quantity to be derived based on CSI-RS;
   2> derive each configured beam measurement quantity based on CSI-RS as described in TS 38.215 [9], and apply layer 3 beam filtering as described in 5.5.3.2.

In step 1e-25, the UE 1e-01 may determine whether a measurement report should be triggered based on the measurement configuration information received in step 1e-15. (Determine whether measurement reporting for a configured event is triggered or not)

First, the UE 1e-01 may determine cells applied to eventA4 depending on whether useAllowedCellList is set to true for the eventA4, as follows.
If useAllowedCellList is set to true, the UE may consider any neighbouring cell detected based on parameters in the measObjectNR associated with the measId (i.e., the measId that connects the reportConfig configured with the event A4 and the measObjectNR associated with the reportConfig), among the cells included in allowedCellsToAddModList defined in VarMeasConfig, are applicable (consider any neighbouring cell detected based on parameters in the associated measObjectNR to be applicable when the concerned cell is included in the allowedCellsToAddModList defined within the VarMeasConfig for this measId).
If useAllowedCellList is not set to true, the UE may consider any neighbouring cell detected based on parameters in the measObjectNR associated with the measId (i.e., the measId that connects the reportConfig configured with the eventA4 and the measObjectNR associated with the reportConfig) are applicable, while the cell is not included in the excludedCellsToAddModList defined within the VarMeasConfig for this measId (consider any neighbouring cell detected based on parameters in the associated measObjectNR to be applicable when the concerned cell is not included in the excludedCellsToAddModList defined within the VarMeasConfig for this measId).

Then, in step 1e-15, the UE may determine whether there is a first cell that fulfills the following entry condition for the eventA4 described above.
If the reportType is set to eventTriggered and if the entry condition for the eventA4 is fulfilled, i.e., the eventId of the reportConfig within VarMeasConfig is the eventA4, and all measurements that have performed layer 3 filtering on one or more cells applicable to the eventA4 fulfill the entering condition described above in step 1e-15 during the timeToTrigger defined in the event, and the VarMeasReportList does not include the measurement reporting entry for the measId (the measId refers to an identifier that connects a reporting configuration and a measurement object, and herein refers to the measId that connects the reportConfig and the MeasObjectNR mapped to the reportConfig) associated with the event (if the reportType is set to eventTriggered and if the entry condition applicable for this event, i.e., the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event)).

If the above conditions are fulfilled, the UE 1e-01 may perform the following procedures.
include a measurement reporting entry within the VarMeasReportList for this measId;
set the numberOfReportsSent defined within the VarMeasReportList for this measId to 0;
include the concerned cell(s) in the cellsTriggeredList defined within the VarMeasReportList for this measId;
if useT312 is set to true in reportConfig for this event:
   if T310 for the corresponding SpCell is running; and
   if T312 is not running for corresponding SpCell:
      start timer T312 for the corresponding

SpCell with the value of T312 configured in the corresponding measObjectNR;
initiate the measurement reporting procedure, as specified in 1e-30;

Alternatively, in step 1e-15, the UE 1e-01 may determine whether there is a subsequent cell that fulfils the entry conditions for the above-described eventA4.
If the reportType is set to eventTriggered and the entry condition for the eventA4 is fulfilled, i.e., the eventId of the reportConfig within VarMeasConfig is the eventA4, and all measurements that have performed layer 3 filtering on one or more applicable cells not included in the cellsTriggeredList fulfill the entering condition described above in step 1e-15 during the timeToTrigger defined in the event (else if the reportType is set to eventTriggered and if the entry condition applicable for this event, i.e., the event corresponding with the eventId of the corresponding reportConfig within VarMeasConfig, is fulfilled for one or more applicable cells not included in the cellsTriggeredList for all measurements after layer 3 filtering taken during time To Trigger defined for this event within the VarMeasConfig (a subsequent cell triggers the event)).

When the above condition is fulfilled, the UE may perform the following procedures.
set the numberOfReportsSent defined within the VarMeasReportList for this measId to 0;
include the concerned cell(s) in the cellsTriggeredList defined within the VarMeasReportList for this measId;
if useT312 is set to true in reportConfig for this event:
   if T310 for the corresponding SpCell is running; and
   if T312 is not running for corresponding SpCell:
      start timer T312 for the corresponding SpCell with the value of T312 configured in the corresponding measObjectNR;
initiate the measurement reporting procedure, as specified in 1e-30;

Alternatively, in step 1e-15, the UE 1e-01 may determine whether there are cells that fulfill the following leaving conditions for the above-described eventA4.
If the reportType is set to eventTriggered and if the leaving condition for the eventA4 is fulfilled, i.e., the eventId of the reportConfig within VarMeasConfig is the eventA4, and all measurements that have performed layer 3 filtering on one or more applicable cells included in the cellsTriggeredList fulfill the leaving condition described above in step 1e-15 during the timeToTrigger defined in the event (if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event).

If the above conditions are fulfilled, the UE 1e-01 may perform the following procedures.
remove the concerned cell(s) in the cellsTriggeredList defined within the VarMeasReportList for this measId;
if reportOnLeave is set to true for the corresponding reporting configuration:
   initiate the measurement reporting procedure, as specified in 1e-30;
if the cellsTriggeredList defined within the VarMeasReportList for this measId is empty:
   remove the measurement reporting entry within the VarMeasReportList for this measId;
   stop the periodical reporting timer for this measId, if running;

In step 1e-30, the UE 1e-01 may report the measurement results to the base station 1e-02.

Specifically, in step 1e-25, when the measurement reporting procedure is initiated, the UE 1e-01 may transmit the measurement result message (MeasurementReport) to the base station 1e-02 according to the following procedures.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measurement configuration associated with the SCG;
         4> if reportConfig associated with the measId that triggered the measurement reporting includes reportAddNeighMeas:
         5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rs Type included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report;
         4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig as described in 5.5.5.2, where availability is considered according to the measurement configuration associated with the SCG;
1> if there is at least one applicable neighbouring cell or candidate L2 U2N Relay UE to report:
   2> if the reportType is set to eventTriggered or periodical:
      3> perform as follows:
         4> set the measResultNeighCells to include the best neighbouring cells up to maxReportCells in accordance with the following:
         5> if the reportType is set to eventTriggered and eventId is not set to eventD1:
         6> include the cells included in the cells TriggeredList as defined within the VarMeasReportList for this measId;
         5> else:
         6> include the applicable cells for which the new measurement results became available since the last periodical reporting or since the measurement was initiated or reset;
         5> for each cell that is included in the measResultNeighCells, include the physCellId;
         5> if the reportType is set to eventTriggered or periodical:
         6> for each included cell, include the layer 3 filtered measured results in accordance with the reportConfig for this measId, ordered as follows:
         7> if the measObject associated with this measId concerns NR:
         8> if rsType in the associated reportConfig is set to ssb:
         9> set resultsSSB-Cell within the measResult to include the SS/PBCH block based quantity(ies) indicated in the reportQuantityCell within the concerned reportConfig, in decreasing order of the sorting quantity, determined as specified in 5.5.5.3, i.e., the best cell is included first;
         9> if reportQuantityRS-Indexes and maxNrofRS-IndexesToReport are configured, include beam measurement information as described in 5.5.5.2;
         8> else if rsType in the associated reportConfig is set to csi-rs:
         9> set resultsCSI-RS-Cell within the measResult to include the CSI-RS based quantity(ies) indicated in the reportQuantityCell within the concerned reportConfig, in decreasing order of the sorting quantity, determined as specified in 5.5.5.3, i.e., the best cell is included first;
         9> if reportQuantityRS-Indexes and maxNrofRS-IndexesToReport are configured, include beam measurement information as described in 5.5.5.2;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;
1> else:
   2> if the reportType is set to periodical or cli-Periodical or rxTxPeriodical:
      3> remove the entry within the VarMeasReportList for this measId;
      3> remove this measId from the measIdList within VarMeasConfig;
1> else if the UE is in (NG) EN-DC:
   2> if SRB3 is configured and the SCG is not deactivated:
      3> submit the MeasurementReport message via SRB3 to lower layers for transmission, upon which the procedure ends;
   2> else:
      3> submit the MeasurementReport message via E-UTRA embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured and the SCG is not deactivated:
         4> submit the MeasurementReport message via SRB3 to lower layers for transmission, upon which the procedure ends;
      3> else:
         4> submit the MeasurementReport message via SRB1 embedded in NR RRC message ULInformationTransferMRDC as specified in 5.7.2a.3;
1> else:
   2> submit the MeasurementReport message to lower layers for transmission, upon which the procedure ends.

The beam measurement results of the above section 5.5.5.2 may be stored in the MeasurementReport by the UE according to the following procedures.

For beam measurement information to be included in a measurement report the UE shall:
1> if reportType is set to eventTriggered:
   2> consider the trigger quantity as the sorting quantity if available, otherwise RSRP as sorting quantity if available, otherwise RSRQ as sorting quantity if available, otherwise SINR as sorting quantity;
1> set rsIndexResults to include up to maxNrofRS-IndexesToReport SS/PBCH block indexes or CSI-RS indexes in order of decreasing sorting quantity as follows:
   2> if the measurement information to be included is based on SS/PBCH block:
      3> include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation;
      3> if includeBeamMeasurements is set to true, include the SS/PBCH based measurement results for the quantities in reportQuantityRS-Indexes for each SS/PBCH block index;
   2> else if the beam measurement information to be included is based on CSI-RS:
      3> include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation;
      3> if includeBeamMeasurements is set to true, include the CSI-RS based measurement results for the quantities in reportQuantityRS-Indexes for each CSI-RS index.

The cell measurement results of the above section 5.5.5.3 may be stored in the MeasurementReport by the UE according to the following procedures.

The UE shall determine the sorting quantity according to parameters of the reportConfig associated with the measId that triggered the reporting:
1> if the reportType is set to eventTriggered:
   2> for an NR cell, consider the quantity used in the aN-Threshold (for eventA1, eventA2 and eventA4) or in the a5-Threshold2 (for eventA5) or in the aN-Offset (for eventA3 and eventA6) as the sorting quantity; According to an embodiment of the present disclosure, one a4-Threshold may be stored in the report configuration information configured with the eventA4.

FIG. 1F is a flowchart of the process in which the uncrewed aerial vehicle (UAV) UE transmits the event-based measurement result message to the base station in the next-generation mobile communication system according to an embodiment of the present disclosure.

The uncrewed aerial vehicle (UAV) UE may refer to the UE capable of flight. Therefore, the UAV UE may have the higher probability of line-of-sight than the terrestrial UE.

Therefore, the UAV UE may have the disadvantage of receiving the downlink (hereinafter, referred to as DL) interference from more cells than the terrestrial UE. That is, the UAV UE has the characteristic of receiving a higher level of DL interference from more neighbour cells than the terrestrial UE. Similarly, the UAV UE has the characteristics of causing uplink (hereinafter, referred to as UL) interference to more cells than the terrestrial UE.

The present disclosure proposes the method for reporting a MeasurementReport to a base station according to the above-described UAV UE characteristics.

Referring to FIG. 1F, in step 1f-05, a UAV UE 1f-01 may establish a radio resource control (RRC) connection with an NR base station (gNB) 1f-02 and may be in an RRC connected mode (RRC_CONNECTED).

In step 1f-10, the UAV UE 1f-01 may report the UE capability to the base station 1f-02.

For example, the UAV UE 1f-01 may transmit the UE capability information message (UECapabilityInformation) to the base station 1f-02. The UE capability information message may follow the above-described embodiment.

Additionally, when the UE includes configuration values for each altitude or each altitude range in one or more specific parameters stored in one report configuration information (report configuration), the UE capability information message may include capability information (or an indicator) indicating that the UE may support/apply the configuration values.

For example, when a4-Threshold values are respectively configured for each altitude or altitude range in one report configuration information (report configuration), the UE capability information message may include the UE capability information indicating that the UE 1f-01 may support/apply the a4-Threshold values mapped to a specific altitude or altitude range configured by the base station depending on a flight altitude of the UE 1f-01 (e.g., when the flight altitude of the UE is within a specific altitude or altitude range configured by the base station, the UE may apply a4-Threshold 1 to determine whether the eventA4 is triggered, and when the flight altitude of the UE is within another altitude or altitude range configured by the base station, the UE may apply a4-Threshold 2 to determine whether the eventA4 is triggered).

For reference, the UE capability may be supported only when Event H1/H2 is supported.

In step 1f-15, the base station 1f-02 may transmit a predetermined RRC message (e.g., RRCReconfiguration) containing measurement configuration information (MeasConfig) to the UAV UE 1f-01.

This may follow the above-described embodiment. For example, the measurement configuration information (MeasConfig) may include measurement object configuration information (MeasObjectToAddModList) for objects on which measurement is performed, report configuration information (ReportConfigToAddModList), measurement identifier configuration information (MeasIdToAddModList) that identifies a measurement configuration by connecting one reporting configuration and one measurement object configuration information, measurement quantity configuration information (QuantityConfig) that contains measurement quantities and layer 3 filtering coefficients for measurement, etc.

Additionally, one report configuration information that the base station 1f-02 according to an embodiment of the present disclosure configures for the UE 1f-01 may include configuration values for each altitude or each altitude range in one or more specific parameters. For example, a plurality of a4-Thresholds may be configured for the eventA4, and MeasTriggerQuantity may be configured for each a4-Threshold according to a specific altitude or altitude range.

Even when the base station 1f-02 according to an embodiment of the present disclosure configures MeasurementTriggerQuantities for each altitude or altitude range, respectively, the base station 1f-02 may configure the same type of threshold value (same CHOICE name for the MeasurementTriggerQuantity for each a4-Threshold for a specific height (or height region), i.e., same rsrp, same rsrq, or same sinr).

This is because, if different types of threshold values (different CHOICE name for the MeasurementTriggerQuantity for each a4-Threshold for a specific height (or height region)) are respectively configured for the a4-Threshold, when the flight altitude of the UE changes and the a4-Threshold different from the previously applied a4-Threshold is applied, the UE should newly derive measurement results according to the changed a4-Threshold or manage the VarMeasReportList according to the changed a4-Threshold and therefore the measurement results according to the previously applied a4-Threshold may become meaningless.

For reference, a new timer may be configured in the measurement configuration information. The UE 1f-01 may run the new timer when the UE 1f-01 enters the altitude or altitude range configured by the base station 1f-02. When the running timer expires, the UE 1f-01 may apply the a4-Threshold associated with the corresponding altitude or altitude range.

Of course, the UE 1f-01 may stop the running timer when, while the timer is running, the flight altitude of the UE enters the (previous) altitude or altitude range configured by the base station prior to the timer running, or when the UE enters another new altitude or altitude range configured by the base station.

For reference, the UE may not run the new timer when first applying the a4-Threshold. Of course, when the UE enters the altitude or altitude range configured by the base station without the timer running, the UE may immediately apply the a4-Threshold associated with the corresponding altitude or altitude range.

In step 1f-20, the UE 1f-01 may perform the measurement based on the measurement configuration information (MeasConfig) received in step 1f-15.

The measurement may follow the above-described embodiment.

In this case, the UE may apply the a4-Threshold mapped to the altitude or altitude range configured in step 1f-15 according to the altitude of the UE, and may apply the above-described embodiment.

In step 1f-25, the UE 1f-01 may determine whether a measurement report should be triggered based on the measurement configuration information received in step 1f-20.

This may follow the above-described embodiment. In this case, the UE may apply the a4-Threshold mapped to the altitude or altitude range configured in step 1f-15 according to its own altitude, and may apply the above-described embodiment.

In step 1f-30, the UE 1f-01 may report the measurement results to the base station 1f-02.

Specifically, in step 1f-25, when the measurement reporting procedure is initiated, the UE 1f-01 may transmit the measurement result message (MeasurementReport) to the base station 1f-02 according to the following procedures. This may follow the above-described embodiment.

In step 1f-35, the UE 1f-01 may apply a threshold value associated with a new altitude (or altitude range) based on the altitude of the UE 1f-01.

For example, when the UE 1f-01 flies at a (new) altitude different from the altitude at which the UE 1f-01 was flying in step 1f-20, step 1f-25, or step 1f-30 and enters the new altitude or altitude range configured in step 1f-15, the UE may apply an a4-Threshold (i.e., an a4-Threshold mapped to the new altitude or altitude range) different from the a4-Threshold applied in step 1f-20, step 1f-25, or step 1f-30. In this case, the UE 1f-01 may apply the a4-Threshold mapped to the new altitude or altitude range when at least one of the following is fulfilled. For reference, the UE may apply single a4-Threshold at a given specific time or altitude.
When the UE 1f-01 enters the new altitude or altitude range configured in step 1f-15, the a4-Threshold configured to be mapped to the new altitude or altitude range may be immediately applied.
When the UE 1f-01 enters the new altitude or altitude range configured in step 1f-15, the new timer may run. When the running timer expires, the UE may apply the a4-Threshold configured to be mapped to the new altitude or altitude range.
   When the UE 1f-01 enters the new altitude or altitude range configured in step 1f-15,
   1) after a specific set time has elapsed,
   2) after a specific time set by the base station has elapsed (e.g., TimeToTrigger (TTT)), or
   3) when the UE flies at a specific altitude within the new altitude or altitude range,

The a4-Threshold configured to be mapped to the new altitude or altitude range may be applied.

The UE 1f-01 may enter the new altitude or altitude range, apply the above-described a4-Threshold, and perform at least one of the following.
Option 1:
   The UE may remove the measurement reporting entry for the measId associated with the reportConfigId (i.e., the reportConfigId for which eventA4 is configured) from the VarMeasReportList (UE removes the measurement reporting entry for this measId associated with this reportConfigId from the VarMeasReportList, if included).
   The UE may stop the periodic reporting timer, if running, and reset the TTT for this measId.
Option 2:
   The UE may not remove the measurement reporting entry for the measId associated with the reportConfigId (i.e., the reportConfigId for which eventA4 is configured) from the VarMeasReportList (UE does not remove the measurement reporting entry for this measId associated with this reportConfigId from the VarMeasReportList, if included).
   The UE does not stop the periodic reporting timer, if running, and may not reset the TTT for this measId.
Option 3:
   The UE may not remove the measurement reporting entry for the measId associated with the reportConfigId (i.e., the reportConfigId for which eventA4 is configured) from the VarMeasReportList (UE does not remove the measurement reporting entry for this measId associated with this reportConfigId from the VarMeasReportList, if included).
   The UE may stop the periodic reporting timer, if running, and may reset the TTT for this measId.
Option 4:
   Depending on the configuration of the base station, the UE may perform one of the above options. (Based on network indication, the UE performs either Option 1 or 2 or 3)

Further, the UE may determine whether a measurement report should be triggered based on the measurement configuration information received in step 1f-20. This may follow step 1f-25.

In step 1f-40, the UE 1f-01 may report the measurement results to the base station 1f-02.

Specifically, in step 1f-35, when the measurement reporting procedure is initiated, the UE 1f-01 may transmit the measurement result message (MeasurementReport) to the base station 1f-02 according to the following procedures. This may follow the above-described embodiment.

According to an embodiment of the present disclosure, the report configuration information configured with the eventA4 may store the a4-Thresholds for each altitude or altitude range, respectively. The UE may apply a specific a4-Threshold with respect to the a4-Thresholds stored for each altitude or altitude range depending on the flight altitude of the UE. In this case, a method for managing measurement result entry and manage a periodic timer and TTT is proposed.

For reference, when the base station according to an embodiment of the present disclosure configures the a4-Thresholds for each altitude or altitude range, respectively, the measurement trigger quantity value (MeasTriggerQuantity) configured as the a4-Threshold may be configured to the same type of value (e.g., MeasTriggerQuantity is configured for the same rsrp, but a different RSRP-Range value) for each altitude or altitude range.

FIG. 1G is a flowchart of the process in which the uncrewed aerial vehicle (UAV) UE transmits the event-based measurement result message to the base station in the next-generation mobile communication system according to an embodiment of the present disclosure.

The uncrewed aerial vehicle (UAV) UE may refer to the UE capable of flight. Therefore, the UAV UE may have the higher probability of line-of-sight than the terrestrial UE.

Therefore, the UAV UE may have the disadvantage of receiving the downlink (hereinafter, referred to as DL) interference from more cells than the terrestrial UE. That is, the UAV UE has the characteristic of receiving a higher level of DL interference from more neighbour cells than the terrestrial UE. Similarly, the UAV UE has the characteristics of causing uplink (hereinafter, referred to as UL) interference to more cells than the terrestrial UE.

The present disclosure proposes the method for reporting a MeasurementReport to a base station according to the UAV UE characteristics.

Referring to FIG. 1G, in step 1g-05, a UAV UE 1g-01 may establish an RRC connection with an NR base station (gNB) 1g-02 and may be in a radio resource control (RRC) connected mode (RRC_CONNECTED).

In step 1g-10, the UAV UE 1g-01 may report the UE capability to the base station 1g-02.

For example, the UAV UE 1g-01 may transmit the UE capability information message (UECapabilityInformation) to the base station 1g-02. This may follow at least one of the above-described embodiments.

In step 1g-15, the base station 1g-02 may transmit a predetermined RRC message (e.g., RRCReconfiguration) containing measurement configuration information (MeasConfig) to the UAV UE 1g-01.

This may follow at least one of the above-described embodiments. For example, the measurement configuration information (MeasConfig) may include measurement object configuration information (MeasObjectToAddModList) for objects on which measurement is performed, report configuration information (ReportConfigToAddModList), measurement identifier configuration information (MeasIdToAddModList) that identifies a measurement configuration by connecting one reporting configuration and one measurement object configuration information, measurement quantity configuration information (QuantityConfig) that contains measurement quantities and layer 3 filtering coefficients for measurement, etc.

In addition, one report configuration information that the base station 1f-02 according to an embodiment of the present disclosure configures for the UE 1f-01 may include configuration values for each altitude or each altitude range in one or more specific parameters. For example, a plurality of a4-Thresholds may be configured for the eventA4, and MeasTriggerQuantity may be configured for each a4-Threshold according to a specific altitude or altitude range.

Additionally, even when the base station 1g-02 according to an embodiment of the present disclosure configures MeasurementTriggerQuantities for each altitude or altitude range, respectively, the base station 1g-02 may configure different types of threshold values (different CHOICE name for the MeasurementTriggerQuantity for each a4-Threshold for a specific height (or height region) i.e., one for rsrp and the other for rsrq) for each MeasurementTriggerQuantity.

In step 1g-20, the UE 1g-01 may perform the measurement based on the measurement configuration information received in step 1g-15. This may follow at least one of the above-described embodiments.

In step 1g-25, the UE 1g-01 may determine whether a measurement report should be triggered based on the measurement configuration information received in step 1g-20. This may follow at least one of the above-described embodiments.

In step 1g-30, the UE 1g-01 may report the measurement results to the base station 1g-02.

Specifically, in step 1g-25, when the measurement reporting procedure is initiated, the UE 1g-01 may transmit the measurement result message (MeasurementReport) to the base station 1g-02 according to the following procedures. This may follow at least one of the above-described embodiments.

In step 1g-35, the UE 1g-01 may apply a threshold value associated with a new altitude (or altitude range) based on the altitude of the UE 1g-01.

For example, when the UE 1g-01 flies at a (new) altitude different from the altitude at which the UE 1g-01 was flying in step 1g-20, step 1g-25, or step 1g-30 and enters the new altitude or altitude range configured in step 1g-15, the UE may apply an a4-Threshold (i.e., an a4-Threshold mapped to the new altitude or altitude range) different from the a4-Threshold applied in step 1g-20, step 1g-25, or step 1g-30.

In this case, the UE 1g-35 may apply the a4-Threshold mapped to the new altitude or altitude range when at least one of the following is fulfilled. For reference, the UE may apply a single a4-Threshold at a given specific time or altitude.
When the UE 1g-01 enters the new altitude or altitude range configured in step 1g-15, the a4-Threshold configured to be mapped to the new altitude or altitude range may be immediately applied.
When the UE 1g-01 enters the new altitude or altitude range configured in step 1g-15, the new timer may run. When the running timer expires, the UE may apply the a4-Threshold configured to be mapped to the new altitude or altitude range.
When the UE 1g-01 enters the new altitude or altitude range configured in step 1g-15,
   1) after a specific set time has elapsed,
   2) after a specific time set by the base station has elapsed (e.g., TimeToTrigger (TTT)), or
   3) when the UE flies at a specific altitude within the new altitude or altitude range,

The a4-Threshold configured to be mapped to the new altitude or altitude range may be applied.

The UE 1g-01 may enter the new altitude or altitude range, apply the above-described a4-Threshold, and perform at least one of the following procedures. For reference, if the same type of threshold value is configured for the a4-Threshold, this may follow the above-described embodiment. In other words, the following description is directed to the case where different types of threshold values are configured for the a4-Threshold.
Option 1:
   The UE may remove the measurement reporting entry for the measId associated with the reportConfigId (i.e., the reportConfigId for which eventA4 is configured) from the VarMeasReportList (UE removes the measurement reporting entry for this measId associated with this reportConfigId from the VarMeasReportList, if included).
   The UE stop the periodic reporting timer, if running, and reset the TTT for this measId.
Option 2:
   The UE may remove the measurement reporting entry for the measId associated with the reportConfigId (i.e., the reportConfigId for which eventA4 is configured) from the VarMeasReportList (UE removes the measurement reporting entry for this measId associated with this reportConfigId from the VarMeasReportList, if included).
   The UE does not stop the periodic reporting timer, if running, and does not reset the TTT for this measId.
Option 3:
   Depending on the configuration of the base station, the UE may perform one of the above options. (Based on network indication, the UE performs either Option 1 or 2)

For reference, the UE may continuously run the periodic timer and reset only the TTT. In this case, when the periodic timer expires, the timer may not be restarted unless a subsequent measurement report is triggered. Alternatively, the UE may reset only the TTT and stop only the periodic timer.

Further, the UE may determine whether a measurement report should be triggered based on the measurement configuration information received in step 1g-20. This may follow step 1g-25.

In step 1g-40, the UE 1g-01 may report the measurement results to the base station 1g-02.

Specifically, in step 1g-35, when the measurement reporting procedure is initiated, the UE 1g-01 may transmit the measurement result message (MeasurementReport) to the base station 1g-02 according to the following procedures. This may follow the above-described embodiment.

According to an embodiment of the present disclosure, the report configuration information configured with the eventA4 may store the a4-Thresholds for each altitude or altitude range, respectively. The UE may apply a specific a4-Threshold with respect to the a4-Thresholds stored for each altitude or altitude range depending on the flight altitude of the UE. In this case, a method for managing measurement result entry and manage a periodic timer and TTT is proposed.

When the base station according to an embodiment of the present disclosure configures the a4-Thresholds for each altitude or altitude range, respectively, the measurement trigger quantity value (MeasTriggerQuantity) configured as the a4-Threshold may be configured to different types of values (e.g., the MeasTriggerQuantity is configured for one a4-Threshold based on the RSRP-Range, and the MeasurementQuantity is configured for another a4-Threshold based on the RSRQ-Range) for each altitude or altitude range.

FIG. 1H is a flowchart of a process in which the uncrewed aerial vehicle (UAV) UE efficiently reports a MeasurementReport to the base station in the next-generation mobile communication system according to an embodiment of the present disclosure.

The uncrewed aerial vehicle (UAV) UE may refer to the UE capable of flight.

Referring to FIG. 1H, in step 1h-05, a UAV UE 1h-01 may establish a radio resource control (RRC) connection with an NR base station (gNB) 1h-02 and may be in an RRC connected mode (RRC_CONNECTED). In step 1h-10, the UAV UE 1h-01 may report the UE capability to the base station 1h-02.

For example, the UE 1h-01 may transmit the UE capability information message (UECapability Information) to the base station 1h-02.

The UE capability information message may include information (multipleCellsMeasExtension) indicating whether numberOfTriggeringCells is supported in the measurement reporting configuration (reporting configuration). The multipleCellsMeasExtension indicates whether the UE has the capability to report the MeasurementReport to the base station by determining whether the number of cells (numberOfTriggeringCells) configured by the base station, rather than a single cell, simultaneously fulfill a specific event condition when determining whether the UE fulfills the specific event condition.

In step 1h-15, the base station 1h-02 may transmit a predetermined RRC message (e.g., RRCReconfiguration) containing measurement configuration information (MeasConfig) to the UAV UE 1h-01.

For example, the measurement configuration information may store report configuration information (reportConfigToAddModList) containing event triggering conditions.

The ReportConfigToAddModList may be composed of one or more ReportConfigToAddMod, and each ReportConfigToAddMod may be configured as follows.

According to an embodiment of the present disclosure, the reportType may be configured to eventTriggered, and the predetermined event configuration information (e.g., EventA3, EventA4, EventA5, EventB1, EventB2) may include numberOfTriggeringCells.

The numberOfTriggeringCells may refer to the number of one or more detected cells for which a predetermined event that triggers a measurement report is to be fulfilled (the number of cells detected that are required to fulfill an event for a measurement report to be triggered).

For reference, the event conditions may be as follows.

5.5.4.4 Event A3 (Neighbour Becomes Offset Better than SpCell)

The UE shall:
1> consider the entering condition for this event to be satisfied when condition A3-1, as specified below, is fulfilled;
1> consider the leaving condition for this event to be satisfied when condition A3-2, as specified below, is fulfilled;
1> use the SpCell for Mp, Ofp and Ocp.

NOTE 1: The cell(s) that triggers the event has reference signals indicated in the measObjectNR associated to this event which may be different from the NR SpCell measObjectNR.

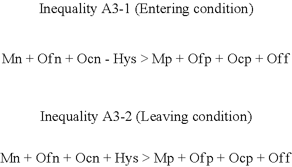

The variables in the formula are defined as follows:

Mn is the measurement result of the neighbouring cell, not taking into account any offsets.

Ofn is the measurement object specific offset of the reference signal of the neighbour cell (i.e., offsetMO as defined within measObjectNR corresponding to the neighbour cell).

Ocn is the cell specific offset of the neighbour cell (i.e., cellIndividualOffset as defined within measObjectNR corresponding to the frequency of the neighbour cell), and set to zero if not configured for the neighbour cell.

Mp is the measurement result of the SpCell, not taking into account any offsets.

Ofp is the measurement object specific offset of the SpCell (i.e., offsetMO as defined within measObjectNR corresponding to the SpCell).

Ocp is the cell specific offset of the SpCell (i.e., cellIndividualOffset as defined within measObjectNR corresponding to the SpCell), and is set to zero if not configured for the SpCell.

Hys is the hysteresis parameter for this event (i.e., hysteresis as defined within reportConfigNR for this event).

Off is the offset parameter for this event (i.e., a3-Offset as defined within reportConfigNR for this event).

Mn, Mp are expressed in dBm in case of RSRP, or in dB in case of RSRQ and RS-SINR.

Ofn, Ocn, Ofp, Ocp, Hys, Off are expressed in dB.

NOTE 2: The definition of Event A3 also applies to CondEvent A3.

5.5.4.5 Event A4 (Neighbour Becomes Better than Threshold)

The UE shall:
1> consider the entering condition for this event to be satisfied when condition A4-1, as specified below, is fulfilled;
1> consider the leaving condition for this event to be satisfied when condition A4-2, as specified below, is fulfilled.

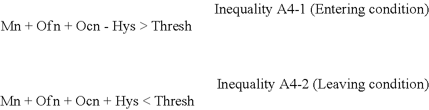

The variables in the formula are defined as follows:

Mn is the measurement result of the neighbouring cell, not taking into account any offsets.

Ofn is the measurement object specific offset of the neighbour cell (i.e., offsetMO as defined within measObjectNR corresponding to the neighbour cell).

Ocn is the measurement object specific offset of the neighbour cell (i.e., cellIndividualOffset as defined within measObjectNR corresponding to the neighbour cell), and set to zero if not configured for the neighbour cell.

Hys is the hysteresis parameter for this event (i.e., hysteresis as defined within reportConfigNR for this event).

Thresh is the threshold parameter for this event (i.e., a4-Threshold as defined within reportConfigNR for this event),

Mn is expressed in dBm in case of RSRP, or in dB in case of RSRQ and RS-SINR.

Ofn, Ocn, Hys are expressed in dB.

Thresh is expressed in the same unit as Mn.

NOTE: The definition of Event A4 also applies to CondEvent A4.

5.5.4.6 Event A5 (SpCell Becomes Worse than Threshold1 and Neighbour Becomes Better than Threshold2)

The UE shall:
1> consider the entering condition for this event to be satisfied when both condition A5-1 and condition A5-2, as specified below, are fulfilled;
1> consider the leaving condition for this event to be satisfied when condition A5-3 or condition A5-4, i.e., at least one of the two, as specified below, is fulfilled;
1> use the SpCell for Mp.

NOTE 1: The parameters of the reference signal(s) of the cell(s) that triggers the event are indicated in the measObjectNR associated to the event which may be different from the measObjectNR of the NR SpCell.

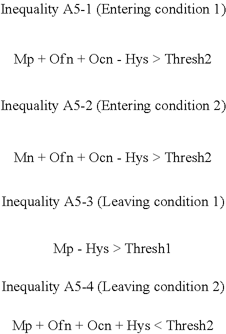

The variables in the formula are defined as follows:

Mp is the measurement result of the NR SpCell, not taking into account any offsets.

Mn is the measurement result of the neighbouring cell, not taking into account any offsets.

Ofn is the measurement object specific offset of the neighbour cell (i.e., offsetMO as defined within measObjectNR corresponding to the neighbour cell).

Ocn is the cell specific offset of the neighbour cell (i.e., cellIndividualOffset as defined within measObjectNR corresponding to the neighbour cell), and set to zero if not configured for the neighbour cell.

Hys is the hysteresis parameter for this event (i.e., hysteresis as defined within reportConfigNR for this event).

Thresh1 is the threshold parameter for this event (i.e., a5-Threshold1 as defined within reportConfigNR for this event).

Thresh2 is the threshold parameter for this event (i.e., a5-Threshold2 as defined within reportConfigNR for this event).

Mn, Mp are expressed in dBm in case of RSRP, or in dB in case of RSRQ and RS-SINR.

Ofn, Ocn, Hys are expressed in dB.

Thresh1 is expressed in the same unit as Mp.

Thresh2 is expressed in the same unit as Mn.

NOTE 2: The definition of Event A5 also applies to CondEvent AS.

5.5.4.8 Event B1 (Inter RAT Neighbour Becomes Better than Threshold)

The UE shall:
1> consider the entering condition for this event to be satisfied when condition B1-1, as specified below, is fulfilled;
1> consider the leaving condition for this event to be satisfied when condition B1-2, as specified below, is fulfilled.

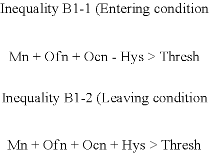

The variables in the formula are defined as follows:

Mn is the measurement result of the inter-RAT neighbour cell, not taking into account any offsets.

Ofn is the measurement object specific offset of the frequency of the inter-RAT neighbour cell (i.e., eutra-Q-OffsetRange as defined within the measObjectEUTRA corresponding to the frequency of the neighbour inter-RAT cell, utra-FDD-Q-OffsetRange as defined within the measObjectUTRA-FDD corresponding to the frequency of the neighbour inter-RAT cell).

Ocn is the cell specific offset of the inter-RAT neighbour cell (i.e., cellIndividualOffset as defined within the measObjectEUTRA corresponding to the neighbour inter-RAT cell), and set to zero if not configured for the neighbour cell

Hys is the hysteresis parameter for this event (i.e., hysteresis as defined within reportConfigInterRAT for this event).

Thresh is the threshold parameter for this event (i.e., b1-ThresholdEUTRA as defined within reportConfigInterRAT for this event, b1-ThresholdUTRA-FDD as defined for UTRA-FDD within reportConfigInterRAT for this event).

Mn is expressed in dBm or in dB, depending on the measurement quantity of the inter-RAT neighbour cell.

Ofn, Ocn, Hys are expressed in dB.

Thresh is expressed in the same unit as Mn.

5.5.4.9 Event B2 (PCell Becomes Worse than Threshold1 and Inter RAT Neighbour Becomes Better than Threshold2)

The UE shall:
1> consider the entering condition for this event to be satisfied when both condition B2-1 and condition B2-2, as specified below, are fulfilled;
1> consider the leaving condition for this event to be satisfied when condition B2-3 or condition B2-4, i.e., at least one of the two, as specified below, is fulfilled;

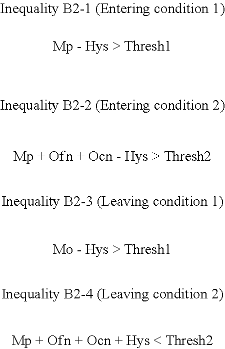

The variables in the formula are defined as follows:

Mp is the measurement result of the PCell, not taking into account any offsets.

Mn is the measurement result of the inter-RAT neighbour cell, not taking into account any offsets.

Ofn is the measurement object specific offset of the frequency of the inter-RAT neighbour cell (i.e., eutra-Q-OffsetRange as defined within the measObjectEUTRA corresponding to the frequency of the inter-RAT neighbour cell, utra-FDD-Q-OffsetRange as defined within the measObjectUTRA-FDD corresponding to the frequency of the neighbour inter-RAT cell).

Ocn is the cell specific offset of the inter-RAT neighbour cell (i.e., cellIndividualOffset as defined within the measObjectEUTRA corresponding to the neighbour inter-RAT cell), and set to zero if not configured for the neighbour cell.

Hys is the hysteresis parameter for this event (i.e., hysteresis as defined within reportConfigInterRAT for this event).

Thresh1 is the threshold parameter for this event (i.e., b2-Threshold 1 as defined within reportConfigInterRAT for this event).

Thresh2 is the threshold parameter for this event (i.e., b2-Threshold2EUTRA as defined within reportConfigInterRAT for this event, b2-Threshold2UTRA-FDD as defined for UTRA-FDD within reportConfigInterRAT for this event).

Mp is expressed in dBm in case of RSRP, or in dB in case of RSRQ and SINR.

Mn is expressed in dBm or dB, depending on the measurement quantity of the inter-RAT neighbour cell.

Ofn, Ocn, Hys are expressed in dB.

Thresh1 is expressed in the same unit as Mp.

Thresh2 is expressed in the same unit as Mn.

In step 1h-20, the UE 1h-01 may determine whether a measurement report should be triggered based on the measurement configuration information received in step 1h-15.

Specifically, the UE 1h-01 may determine to trigger the measurement report when at least one of the following conditions is fulfilled.
2> if the reportType is set to eventTriggered and if the corresponding reportConfig includes numberOfTriggeringCells, and if the entry condition applicable for this event, i.e., the event corresponding with the eventId of the corresponding reportConfig within VarMeasConfig, is fulfilled for one or more applicable cells for all measurements after layer 3 filtering taken during timeToTrigger defined for this event within the VarMeasConfig:
   3> If the VarMeasReportList does not include a measurement reporting entry for this measId (a first cell triggers the event):
      4> include a measurement reporting entry within the VarMeasReportList for this measId;
   3> If the number of cell(s) in the cellsTriggeredList is larger than or equal to numberOfTriggeringCells:
      4> include the concerned cell(s) in the cellsTriggeredList defined within the VarMeasReportList for this measId;
   3> else:
      4> include the concerned cell(s) in the cells TriggeredList defined within the VarMeasReportList for this measId;
      4> If the number of cell(s) in the cellsTriggeredList is larger than or equal to numberOfTriggeringCells:
         5> set the numberOfReportsSent defined within the VarMeasReportList for this measId to 0;
         5> initiate the measurement reporting procedure, as specified in 1h-25
2> if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
   3> remove the concerned cell(s) in the cellsTriggeredList defined within the VarMeasReportList for this measId;
   3> if reportOnLeave is set to TRUE for the corresponding reporting configuration and concerned cell(s) in the cellsTriggeredList are removed defined within the VarMeasReportList for this measId;
      4> initiate the measurement reporting procedure, as specified in 1h-25;
   3> if the cellsTriggeredList defined within the VarMeasReportList for this measId is empty:
      4> remove the measurement reporting entry within the VarMeasReportList for this measId;
      4> stop the periodical reporting timer for this measId, if running;

In step 1h-25, the UE 1h-01 may report the measurement results to the base station 1h-02.

Specifically, when the UE 1h-01 determines that the measurement report is triggered in step 1h-20, the UE 1h-01 may transmit a MeasurementReport to the base station 1h-02. The specific procedure for the UE 1h-01 to transmit the MeasurementReport to the base station 1h-01 may be as follows.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS:
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rs Type indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measurement configuration associated with the SCG;
         4> if reportConfig associated with the measId that triggered the measurement reporting includes reportAddNeighMeas:
         5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rsType included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report;
         4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultBestNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig as described in 5.5.5.2, where availability is considered according to the measurement configuration associated with the SCG;
1> if the measRSSI-ReportConfig is configured within the corresponding reportConfig for this measId:
   2> set the rssi-Result to the linear average of sample value(s) provided by lower layers in the reportInterval;
   2> set the channelOccupancy to the rounded percentage of sample values which are beyond the channelOccupancyThreshold within all the sample values in the reportInterval;
1> if the UE is acting as L2 U2N Remote UE:
   2> set the sl-MeasResultServingRelay to include the SL-RSRP of the serving L2 U2N Relay UE;
NOTE 1: In case of no data transmission from L2 U2N Relay UE to L2 U2N Remote UE, it is left to UE implementation whether to use SL-RSRP or SD-RSRP when setting the sl-MeasResultServingRelay of the serving L2 U2N Relay UE.
1> if there is at least one applicable neighbouring cell or candidate L2 U2N Relay UE to report:
   2> if the reportType is set to eventTriggered or periodical:
      3> if the measurement report concerns the candidate L2 U2N Relay UE:
         4> set the sl-MeasResultsCandRelay in measResultNeighCells to include the best candidate L2 U2N Relay UEs up to maxReportCells in accordance with the following:
         5> if the reportType is set to eventTriggered:
         6> include the L2 U2N Relay UEs included in the relaysTriggeredList as defined within the VarMeasReportList for this measId;
         5> else:
         6> include the applicable L2 U2N Relay UEs for which the new measurement results became available since the last periodical reporting or since the measurement was initiated or reset;
         5> for each L2 U2N Relay UE that is included in the sl-MeasResultsCandRelay:
         6> include the sl-RelayUE-Identity;
         5> for each included L2 U2N Relay UE, include the layer 3 filtered measured results in accordance with the reportConfig for this measId, ordered as follows:
         6> set the sl-MeasResult to include the quantity(ies) indicated in the reportQuantityRelay within the concerned reportConfigRelay in decreasing order of the sorting quantity, determined as specified in 5.5.5.3, i.e., the best L2 U2N Relay UE is included first;
      3> else:
         4> set the measResultNeighCells to include the best neighbouring cells up to maxReportCells in accordance with the following:
         5> if the reportType is set to eventTriggered and eventId is not set to eventD1:
         6> include the cells included in the cellsTriggeredList as defined within the VarMeasReportList for this measId;
         5> else:
         6> include the applicable cells for which the new measurement results became available since the last periodical reporting or since the measurement was initiated or reset;
         5> for each cell that is included in the measResultNeighCells, include the physCellId;
         5> if the reportType is set to eventTriggered or periodical:
         6> for each included cell, include the layer 3 filtered measured results in accordance with the reportConfig for this measId, ordered as follows:
         7> if the measObject associated with this measId concerns NR:
         8> if rsType in the associated reportConfig is set to ssb:
         9> set resultsSSB-Cell within the measResult to include the SS/PBCH block based quantity(ies) indicated in the reportQuantityCell within the concerned reportConfig, in decreasing order of the sorting quantity, determined as specified in 5.5.5.3, i.e., the best cell is included first;
         9> if reportQuantityRS-Indexes and maxNrofRS-IndexesToReport are configured, include beam measurement information as described in 5.5.5.2;
         8> else if rsType in the associated reportConfig is set to csi-rs:
         9> set resultsCSI-RS-Cell within the measResult to include the CSI-RS based quantity(ies) indicated in the reportQuantityCell within the concerned reportConfig, in decreasing order of the sorting quantity, determined as specified in 5.5.5.3, i.e., the best cell is included first;
         9> if reportQuantityRS-Indexes and maxNrofRS-IndexesToReport are configured, include beam measurement information as described in 5.5.5.2;
         7> if the measObject associated with this measId concerns E-UTRA:
         8> set the measResult to include the quantity(ies) indicated in the reportQuantity within the concerned reportConfigInterRAT in decreasing order of the sorting quantity, determined as specified in 5.5.5.3, i.e., the best cell is included first;
         7> if the measObject associated with this measId concerns UTRA-FDD and if ReportConfigInterRAT includes the reportQuantity UTRA-FDD:
         8> set the measResult to include the quantity(ies) indicated in the reportQuantityUTRA-FDD within the concerned reportConfigInterRAT in decreasing order of the sorting quantity, determined as specified in 5.5.5.3, i.e., the best cell is included first;
   2> else:
      3> if the cell indicated by cellForWhichToReportCGI is an NR cell:
         4> if plmn-IdentityInfoList of the cgi-Info for the concerned cell has been obtained:
         5> include the plmn-IdentityInfoList including plmn-IdentityList, trackingAreaCode (if available), trackingAreaList (if available), ranac (if available), cellIdentity and cellReservedForOperatorUse for each entry of the plmn-IdentityInfoList;
         5> include frequencyBandList if available;
         5> for each PLMN-IdentityInfo in plmn-IdentityInfoList:
         6> if the gNB-ID-Length is broadcast:
         7> include gNB-ID-Length;
         4> if nr-CGI-Reporting-NPN is supported by the UE and npn-IdentityInfoList of the cgi-Info for the concerned cell has been obtained:
         5> include the npn-IdentityInfoList including npn-IdentityList, trackingAreaCode, ranac (if available), cellIdentity and cellReservedForOperatorUse for each entry of the npn-IdentityInfoList;
         5> for each NPN-IdentityInfo in NPN-IdentityInfoList:
         6> if the gNB-ID-Length is broadcast:
         7> include gNB-ID-Length;
         5> include cellReservedForOtherUse if available;
         4> else if MIB indicates the SIB1 is not broadcast:
         5> include the noSIB1 including the ssb-SubcarrierOffset and pdcch-ConfigSIB1 obtained from MIB of the concerned cell;
      3> if the cell indicated by cellForWhichToReportCGI is an E-UTRA cell:
         4> if all mandatory fields of the cgi-Info-EPC for the concerned cell have been obtained:
         5> include in the cgi-Info-EPC the fields broadcasted in E-UTRA SystemInformationBlockType1 associated to EPC;
         4> if the UE is E-UTRA/5GC capable and all mandatory fields of the cgi-Info-5GC for the concerned cell have been obtained:
         5> include in the cgi-Info-5GC the fields broadcasted in E-UTRA SystemInformationBlockType1 associated to 5GC;
         4> if the mandatory present fields of the cgi-Info for the cell indicated by the cellForWhichToReportCGI in the associated measObject have been obtained:
         5> include the freqBandIndicator;
         5> if the cell broadcasts the multiBandInfoList, include the multiBandInfoList;
         5> if the cell broadcasts the freqBandIndicatorPriority, include the freqBandIndicatorPriority;
1> if the corresponding measObject concerns NR:
   2> if the reportSFTD-Meas is set to true within the corresponding reportConfigNR for this measId:
      3> set the measResultSFTD-NR in accordance with the following:
         4> set sfn-OffsetResult and frameBoundaryOffsetResult to the measurement results provided by lower layers;
         4> if the reportRSRP is set to true;
         5> set rsrp-Result to the RSRP of the NR PSCell derived based on SSB;
   2> else if the reportSFTD-NeighMeas is included within the corresponding reportConfigNR for this measId:
      3> for each applicable cell which measurement results are available, include an entry in the measResultCellListSFTD-NR and set the contents as follows:
         4> set physCellId to the physical cell identity of the concerned NR neighbour cell.
         4> set sfn-OffsetResult and frameBoundaryOffsetResult to the measurement results provided by lower layers;
         4> if the reportRSRP is set to true:
         5> set rsrp-Result to the RSRP of the concerned cell derived based on SSB;
1> else if the corresponding measObject concerns E-UTRA:
   2> if the reportSFTD-Meas is set to true within the corresponding reportConfigInterRAT for this measId:
      3> set the measResultSFTD-EUTRA in accordance with the following:
         4> set sfn-OffsetResult and frameBoundaryOffsetResult to the measurement results provided by lower layers;
         4> if the reportRSRP is set to true;
         5> set rsrpResult-EUTRA to the RSRP of the EUTRA PSCell;
1> if average uplink PDCP delay values are available:
   2> set the ul-PDCP-DelayValueResultList to include the corresponding average uplink PDCP delay values;
1> if PDCP excess delay measurements are available:
   2> set the ul-PDCP-ExcessDelayResultList to include the corresponding PDCP excess delay measurements;
1> if the includeCommonLocationInfo is configured in the corresponding reportConfig for this measId and detailed location information that has not been reported is available, set the content of commonLocationInfo of the locationInfo as follows:
   2> include the location Timestamp,
   2> include the locationCoordinate, if available;
   2> include the velocityEstimate, if available;
   2> include the locationError, if available;
   2> include the locationSource, if available;
   2> if available, include the gnss-TOD-msec,
1> if the coarseLocationRequest is set to true in the corresponding reportConfig for this measId:
   2> if available, include coarseLocationInfo;
1> if the includeWLAN-Meas is configured in the corresponding reportConfig for this measId, set the wlan-LocationInfo of the locationInfo in the measResults as follows:
   2> if available, include the Log MeasResultWLAN, in order of decreasing RSSI for WLAN APs;
1> if the includeBT-Meas is configured in the corresponding reportConfig for this measId, set the BT-LocationInfo of the locationInfo in the measResults as follows:
   2> if available, include the Log MeasResultBT, in order of decreasing RSSI for Bluetooth beacons;
1> if the includeSensor-Meas is configured in the corresponding reportConfig for this measId, set the sensor-LocationInfo of the locationInfo in the measResults as follows:
   2> if available, include the sensor-MeasurementInformation;
   2> if available, include the sensor-MotionInformation;
1> if there is at least one applicable transmission resource pool for NR sidelink communication (for measResultsSL):
   2> set the measResultsListSL to include the CBR measurement results in accordance with the following:
      3> if the reportType is set to eventTriggered:
         4> include the transmission resource pools included in the poolsTriggeredList as defined within the VarMeasReportList for this measId;
      3> else:
         4> include the applicable transmission resource pools for which the new measurement results became available since the last periodical reporting or since the measurement was initiated or reset;
      3> if the corresponding measObject concerns NR sidelink communication, then for each transmission resource pool to be reported:
         4> set the sl-poolReportIdentity to the identity of this transmission resource pool;
         4> set the sl-CBR-ResultsNR to the CBR measurement results on PSSCH and PSCCH of this transmission resource pool provided by lower layers, if available;
NOTE 1: Void.
1> if there is at least one applicable CLI measurement resource to report:
   2> if the reportType is set to cli-EventTriggered or cli-Periodical:
      3> set the measResultCLI to include the most interfering SRS resources or most interfering CLI-RSSI resources up to maxReportCLI in accordance with the following:
         4> if the reportType is set to cli-EventTriggered:
         5> if trigger quantity is set to srs-RSRP i.e., i1-Threshold is set to srs-RSRP:
         6> include the SRS resource included in the cli-TriggeredList as defined within the VarMeasReportList for this measId;
         5> if trigger quantity is set to cli-RSSI i.e., i1-Threshold is set to cli-RSSI:
         6> include the CLI-RSSI resource included in the cli-TriggeredList as defined within the VarMeasReportList for this measId;
         4> else:
         5> if reportQuantityCLI is set to srs-rsrp:
         6> include the applicable SRS resources for which the new measurement results became available since the last periodical reporting or since the measurement was initialed or reset;
         5> else:
         6> include the applicable CLI-RSSI resources for which the new measurement results became available since the last periodical reporting or since the measurement was initiated or reset;
         4> for each SRS resource that is included in the measResultCLI:
         5> include the srs-ResourceId;
         5> set srs-RSRP-Result to include the layer 3 filtered measured results in decreasing order, i.e., the most interfering SRS resource is included first;
         4> for each CLI-RSSI resource that is included in the measResultCLI:
         5> include the rssi-ResourceId;
         5> set cli-RSSI-Result to include the layer 3 filtered measured results in decreasing order, i.e., the most interfering CLI-RSSI resource is included first;
1> if there is at least one applicable UE Rx-Tx time difference measurement to report:
   2> set measResultRxTxTimeDiff to the latest measurement result;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;
1> else:
   2> if the reportType is set to periodical or cli-Periodical or rxTxPeriodical:
      3> remove the entry within the VarMeasReportList for this measId;
      3> remove this measId from the measIdList within VarMeasConfig;
1> if the measurement reporting was configured by a sl-ConfigDedicatedNR received within the RRCConnectionReconfiguration:
   2> submit the MeasurementReport message to lower layers for transmission via SRB1, embedded in E-UTRA RRC message ULInformationTransferIRAT as specified TS 36.331 [10], clause 5.6.28;
1> else if the UE is in (NG) EN-DC:
   2> if SRB3 is configured and the SCG is not deactivated:
      3> submit the MeasurementReport message via SRB3 to lower layers for transmission, upon which the procedure ends;
   2> else:
      3> submit the MeasurementReport message via E-UTRA embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured and the SCG is not deactivated:
         4> submit the MeasurementReport message via SRB3 to lower layers for transmission, upon which the procedure ends;
      3> else:
         4> submit the MeasureReport message via SRB1 embedded in NR RRC message ULInformationTransferMRDC as specified in 5.7.2a.3;
   2> else:
      3> submit the MeasurementReport message via SRB1 to lower layers for transmission, upon which the procedure ends;
1> else:
   2> submit the MeasurementReport message to lower layers for transmission, upon which the procedure ends.

According to an embodiment of the present disclosure, one numberOfTriggeringCells may be configured for one report configuration, regardless of the altitude.

For reference, an embodiment of the present disclosure may be applied simultaneously with at least one of the above-described embodiments.

FIG. 1I is a flowchart of the process in which the uncrewed aerial vehicle (UAV) UE efficiently reports the MeasurementReport to the base station in the next-generation mobile communication system according to an embodiment of the present disclosure.

The uncrewed aerial vehicle (UAV) UE may refer to the UE capable of flight. Referring to FIG. 1I, in step 1i-05, a UAV UE 1i-01 may establish a radio resource control (RRC) connection with an NR base station (gNB) 1i-02 and may be in an RRC connected mode (RRC_CONNECTED).

In step 1i-10, the UAV UE 1i-01 may report the UE capability to the base station 1i-02

For example, the UE 1i-01 may transmit the UE capability information message (UECapabilityInformation) to the base station 1i-02. This may follow at least one of the above-described embodiments.

Additionally, when the UE includes configuration values for each altitude or each altitude range in one or more specific parameters stored in one report configuration information (report configuration), the UE capability information message may include capability information (or an indicator) indicating that the UE may support/apply the configuration values.

For example, when values of numberOfTriggeringCells are each configured for each altitude or altitude range in one report configuration information (report configuration), the UE capability information message may include the UE capability information indicating that the UE may support/apply the values of the numberOfTriggeringCells mapped to a specific altitude or altitude range configured by the base station depending on the flight altitude of the UE (e.g., when the flight altitude of the UE is within a specific altitude or altitude range configured by the base station, the UE may apply numberOfTriggeringCells 1 to determine whether the eventA4 is triggered, and when the flight altitude of the UE is within another altitude or altitude range configured by the base station, the UE may apply the numberOfTriggeringCells 1 to determine whether the eventA4 is triggered).

For reference, the UE capability may only be supported when supporting Event H1/H2, when supporting multipleCellsMeasExtension, or when supporting both Event H1/H2 and multipleCellsMeasExtension.

In step 1i-15, the base station 1i-02 may transmit a predetermined RRC message (e.g., RRCReconfiguration) containing measurement configuration information (MeasConfig) to the UAV UE 1i-01.

This may follow at least one of the above-described embodiments.

Additionally, one report configuration information that the base station 1i-01 according to an embodiment of the present disclosure configures for the UE 1i-01 may include configuration values for each altitude or each altitude range in one or more specific parameters. For example, a plurality of numberOfTriggeringCells may be configured for the eventA4, and each numberOfTriggeringCells may be configured according to a specific altitude or altitude range.

For reference, a new timer may be configured in the measurement configuration information. The UE may run the new timer when the UE enters the altitude or altitude range configured by the base station. The UE may apply the numberOfTriggeringCells associated with the corresponding altitude or altitude range when the running timer expires. Of course, the UE may stop the running timer when, while the timer is running, the flight altitude of the UE enters the (previous) altitude or altitude range configured by the base station prior to the timer running, or when the UE enters another new altitude or altitude range configured by the base station.

For reference, the UE may not run the new timer when first applying the numberOfTriggeringCells. Of course, when the UE enters the altitude or altitude range configured by the base station without the timer running, the UE may immediately apply the numberOfTriggeringCells associated with the corresponding altitude or altitude range.

In step 1i-20, the UE 1i-01 may determine whether a measurement report should be triggered based on the measurement configuration information received in step 1i-15.

In step 1i-25, the UE 1i-01 may report the measurement results to the base station 1i-02.

Specifically, when the UE 1i-01 determines that the measurement report is triggered in step 1i-20, the UE 1i-01 may transmit a MeasurementReport to the base station 1i-02. This may follow at least one of the above-described embodiments.

In step 1i-30, the UE 1g-01 may apply the numberOfTriggeringCells associated with a new altitude (or altitude range) based on the altitude of the UE 1g-01. For example, when the UE 1i-01 flies at a (new) altitude different from the altitude at which the UE 1i-01 was flying in step 1i-20 or step 1i-25 and enters the new altitude or altitude range configured in step 1i-15, the UE may apply numberOfTriggeringCells (i.e., numberOfTriggeringCells mapped to the new altitude or altitude range) different from the numberOfTriggeringCells applied in step 1i-20 or step 1i-25. In this case, the UE may apply the numberOfTriggeringCells mapped to the new altitude or altitude range when at least one of the following is fulfilled. For reference, the UE may apply a single numberOfTriggeringCells at a given specific time or altitude.

When the UE 1i-01 enters the new altitude or altitude range configured in step 1i-15, the numberOfTriggeringCells configured to be mapped to the new altitude or altitude range may be immediately applied.
When the UE 1i-01 enters the new altitude or altitude range configured in step 1i-15, the new timer may run. When the running timer expires, the UE may apply the numberOfTriggeringCells configured to be mapped to the new altitude or altitude range.
When the UE 1i-01 enters the new altitude or altitude range configured in step 1i-15,
1) after a specific set time has elapsed,
2) after a specific time set by the base station has elapsed (e.g., TimeToTrigger (TTT)), or
3) when the UE flies at a specific altitude within the new altitude or altitude range,

The numberOfTriggeringCells configured to be mapped to the new altitude or altitude range may be applied.

The UE 1i-01 may enter the new altitude or altitude range, apply the above-described numberOfTriggeringCells, and perform at least one of the following.
Option 1:
   The UE may remove the measurement reporting entry for the measId associated with the reportConfigId (i.e., the reportConfigId for which eventA4 is configured) from the VarMeasReportList (UE removes the measurement reporting entry for this measId associated with this reportConfigId from the VarMeasReportList, if included).
   The UE stop the periodic reporting timer, if running, and reset the TTT for this measId.
Option 2:
   The UE may not remove the measurement reporting entry for the measId (i.e., the reportConfigId for which eventA4 is configured) associated with the reportConfigId from the VarMeasReportList (UE does not remove the measurement reporting entry for this measId associated with this reportConfigId from the VarMeasReportList, if included).
   The UE does not stop the periodic reporting timer, if running, and does not reset the TTT for this measId.
Option 3:
   The UE may not remove the measurement reporting entry for the measId (i.e., the reportConfigId for which eventA4 is configured) associated with the reportConfigId from the VarMeasReportList (UE does not remove the measurement reporting entry for this measId associated with this reportConfigId from the VarMeasReportList, if included).
   The UE stop the periodic reporting timer, if running, and reset the TTT for this measId.
Option 4:
   Depending on the configuration of the base station, the UE may perform one of the above options. (Based on network indication, the UE performs either Option 1 or 2 or 3)

Further, the UE may determine whether to trigger the measurement report based on the measurement configuration information received in step 1i-15. This may follow step 1i-20.

In step 1i-35, the UE 1e-01 may report the measurement results to the base station 1e-02.

Specifically, in step 1f-30, when the measurement reporting procedure is initiated, the UE 1i-01 may transmit the measurement result message (MeasurementReport) to the base station 1i-02 according to the following procedures. This may follow the above-described embodiment.

According to an embodiment of the present disclosure, the report configuration information configured with the specific event may store the numberOfTriggeringCells for each altitude or altitude range, respectively. The UE may apply a specific numberOfTriggeringCells with respect to the numberOfTriggeringCells stored for each altitude or altitude range depending on the flight altitude of the UE. In this case, a method for managing measurement result entry and manage a periodic timer and TTT is proposed.

For reference, an embodiment of the present disclosure may be applied simultaneously with at least one of the above-described embodiments.

Referring to FIG. 1J, in step 1j-05, a UAV UE 1j-01 may establish a radio resource control (RRC) connection with an NR base station 1j-02 and may be in an RRC connected mode (RRC_CONNECTED).

The uncrewed aerial vehicle (UAV) UE may refer to the UE capable of flight. In step 1j-10, the UAV UE 1j-01 may report the UE capability to the base station 1j-02.

For example, the UE 1j-01 may transmit the UE capability information message (UECapability Information) to the base station 1j-02. The message may include an indicator (heightMeas) indicating whether the UE supports Event H1/H2. In step 1j-15, the base station 1j-02 may transmit a predetermined RRC message (e.g., RRCReconfiguration) containing measurement configuration information (MeasConfig) to the UB 1j-01.

The measurement configuration information may include a reference altitude threshold value (heightThreshRef) of eventH1 and eventH2 of the report configuration information (ReportConfigNR). The altitude threshold value may be one of integer values, and one integer value may refer to a specific altitude. For example, value 0 may refer to −420 m. For reference, the altitude may be configured based on a specific altitude. For example, the altitude may be expressed by a specific altitude value based on a sea level.

For reference, the reference altitude threshold value may not be expressed by one value, but expressed by a value representing a specific range. For example, value 0 may refer −420 m to −410 m.

The measurement configuration information may store the NR report configuration information (reportConfigNR) containing event H1 or event H2 triggering conditions. In the present disclosure, the reportType of the ReportConfigNR is set to eventTriggered, and the eventH1 or eventH2 may be newly defined in the corresponding EventTriggerConfig as follows. For reference, the base station may configure one or more ReportConfigNRs for the UE

```
ReportConfigNR ::= SEQUENCE {
  reportType CHOICE {
    periodical PeriodicalReportConfig,
    eventTriggered EventTriggerConfig,
    ...,
    reportCGI ReportCGI,
    reportSFTD ReportSFTD-NR,
    condTriggerConfig-r16 CondTriggerConfig-r16,
    cli-Periodical-r16 CLI-PeriodicalReportConfig-r16,
    cli-EventTriggered-r16 CLI-EventTriggerConfig-r16,
    rxTxPeriodical-r17 RxTxPeriodical-r17,
  }
}
EventTriggerConfig ::= SEQUENCE {
  eventId  CHOICE {
    eventA1  SEQUENCE {
      a1-Threshold MeasTriggerQuantity,
      reportOnLeave BOOLEAN,
      hysteresis Hysteresis,
      timeToTrigger TimeToTrigger
    },
    eventA2  SEQUENCE {
      a2-Threshold MeasTriggerQuantity,
      reportOnLeave BOOLEAN,
      hysteresis Hysteresis,
      timeToTrigger TimeToTrigger
    },
    eventA3  SEQUENCE {
      a3-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    eventA4  SEQUENCE {
      a4-Threshold MeasTriggerQuantity,
      reportOnLeave BOOLEAN,
      hysteresis Hysteresis,
      timeToTrigger TimeToTrigger,
      useAllowedCellList BOOLEAN
    },
    eventA5  SEQUENCE {
      a5-Threshold1 MeasTriggerQuantity,
      a5-Threshold2 MeasTriggerQuantity,
      reportOnLeave BOOLEAN,
      hysteresis Hysteresis,
      timeToTrigger TimeToTrigger,
      useAllowedCellList BOOLEAN
    },
    eventA6  SEQUENCE {
      a6-Offset MeasTriggerQuantityOffset,
      reportOnLeave BOOLEAN,
      hysteresis Hysteresis,
      timeToTrigger TimeToTrigger,
      useAllowedCellList BOOLEAN
    },
    ...,
    [[
    eventX1-r17  SEQUENCE {
      x1-Threshold1-Relay-r17  SL-MeasTriggerQuantity-r16,
      x1-Threshold2-r17 MeasTriggerQuantity,
      reportOnLeave-r17 BOOLEAN,
      hysteresis-r17 Hysteresis,
      timeToTrigger-r17 TimeToTrigger,
      useAllowedCellList-r17 BOOLEAN
    },
    eventX2-r17  SEQUENCE {
      x2-Threshold-Relay-r17 SL-MeasTriggerQuantity-r16,
      reportOnLeave-r17 BOOLEAN,
      hysteresis-r17 Hysteresis,
      timeToTrigger-r17 TimeToTrigger
    },
    eventD1-r17  SEQUENCE {
      distanceThreshFromReference1-r17 INTEGER(1.. 65525),
      distanceThreshFromReference2-r17 INTEGER(1.. 65525),
      referenceLocation1-r17 ReferenceLocation-r17,
      referenceLocation2-r17 ReferenceLocation-r17,
      reportOnLeave-r17 BOOLEAN,
      hysteresisLocation-r17 HysteresisLocation-r17,
      timeToTrigger-r17 TimeToTrigger
    }
    ]],
          [[
          eventH1-r18 SEQUENCE {
        h1-ThresholdOffset-r18 INTEGER(0..300),
        h1-Hysteresis-r18 INTEGER(1..16),
            timeToTrigger-r18 TimeToTrigger,
            useAllowedCellList-r18
    BOOLEAN,
```

| | |
|---|---|
| reportOnLeave-r18 | BOOLEAN, |

```
          },
          eventH2-r18 SEQUENCE {
        h2-Threshold-r18 INTEGER(0..300),
        h2-Hysteresis-r18 INTEGER(1..16),
          timeToTrigger-r18
    TimeToTrigger,
            useAllowedCellList-r18
    BOOLEAN,
            reportOnLeave-r18
    BOOLEAN,
        }
        ]]
  },
  rsType NR-RS-Type,
  reportInterval ReportInterval,
  reportAmount ENUMERATED {r1, r2, r4, r8, r16, r32, r64,
infinity},
  reportQuantityCell MeasReportQuantity,
  maxReportCells INTEGER (1..maxCellReport),
```

| | |
|---|---|
| reportQuantityRS-Indexes | MeasReportQuantity |

OPTIONAL, -- Need R

| | |
|---|---|
| maxNrofRS-IndexesToReport | INTEGER (1..maxNrofIndexesToReport) |

OPTIONAL, -- Need R
includeBeamMeasurements BOOLEAN,

| | |
|---|---|
| reportAddNeighMeas | ENUMERATED {setup} |

```
OPTIONAL, -- Need R
  ...,
  [[
```

| | |
|---|---|
| measRSSI-ReportConfig-r16 | MeasRSSI-ReportConfig-r16 |

OPTIONAL, -- Need R

| | |
|---|---|
| useT312-r16 | BOOLEAN |

OPTIONAL, -- Need M

| | |
|---|---|
| includeCommonLocationInfo-r16 | ENUMERATED {true} |

OPTIONAL, -- Need R

| | |
|---|---|
| includeBT-Meas-r16 | SetupRelease {BT-NameList-r16} |

OPTIONAL, -- Need M

| | |
|---|---|
| includeWLAN-Meas-r16 | SetupRelease {WLAN-NameList-r16} |

OPTIONAL, -- Need M

| | |
|---|---|
| includeSensor-Meas-r16 | SetupRelease {Sensor-NameList-r16} |

```
OPTIONAL -- Need M
  ]],
  [[
```

| | |
|---|---|
| coarseLocationRequest-r17 | ENUMERATED {true} |

OPTIONAL, -- Need R

| | |
|---|---|
| reportQuantityRelay-r17 | SL-MeasReportQuantity-r16 |

OPTIONAL -- Need R
]]
}

The predetermined configuration information included in the eventH1 or eventH2 is one example, and may include other integer values. For reference, the measurement configuration information may have the following ASN.1 structure, and the UE may apply the measurement configuration information received from the base station.

-- ASN1START
-- TAG-MEASCONFIG-START
MeasConfig ::= SEQUENCE {

| | |
|---|---|
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

```
OPTIONAL, -- Need N
  s-MeasureConfig  CHOICE {
    ssb-RSRP RSRP-Range,
    csi-RSRP RSRP-Range
  }
OPTIONAL, -- Need M
```

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
  ...,
  [[
```

| | |
|---|---|
| interFrequencyConfig-NoGap-r16 | ENUMERATED {true} |

OPTIONAL -- Need R
]]
}

| | |
|---|---|
| MeasObjectToRemoveList ::= | SEQUENCE (SIZE (1..maxNrofObjectId)) OF |

MeasObjectId

| | |
|---|---|
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId
-- TAG-MEASCONFIG-STOP
-- ASN1STOP

In step 1j-20, the base station 1j-02 may transmit cell group configuration (CellGroupConfig) information to the UE 1j-01.

Specifically, the base station 1j-02 may transmit a predetermined RRC message (e.g., RRCReconfiguration) containing the cell group configuration information (CellGroupConfig) to the UE 1j-01 to configure one or more secondary cells (SCells) and/or spcell cells (SpCells). The CellGroupConfig may include configuration information (ServingCellConfig) dedicated to the UE for each cell, and MeasObjectId may be configured in the ServingCellMO for each ServingCellConfig.

Specifically, the MeasObjectId must always be configured in the ServingCellMO for each SpCell, and the base station may optionally configure the MeasObjectId in the ServingCellMO for each SCell. For reference, step 1j-20 may be performed as in step 1j-15, or step 1j-15 may be performed after step 1j-20.

In step 1j-25, the UE 1j-01 may perform the measurement based on the measurement configuration information received in step 1j-15.

In step 1j-30, the UE 1j-01 may determine whether a measurement report should be triggered based on the measurement configuration information received in step 1j-15.

Specifically, the UE 1j-01 may determine to trigger the measurement report when at least one of the following conditions is fulfilled.
If the reportType is set to eventTriggered and if eventId is set to eventH1 or eventH2 and if the entry (or entering) condition applicable for this event, i.e., the event corresponding with the eventId of the corresponding reportConfig within VarMeasConfig, is fulfilled during timeToTrigger defined within the VarMeasConfig for this event, while the VarMeasReportList does not include a measurement reporting entry for this measId:
   include a measurement reporting entry within the VarMeasReportList for this measId;
   set the numberOfReportSent defined within the VarMeasReportList for this measId to 0;
   initiate the measurement reporting procedure, as specified in 1j-35
If the reportType is set to eventTriggered and if eventId is set to eventH1 or eventH12 and if the leaving condition applicable for this event, i.e., the event corresponding with the eventId of the corresponding reportConfig within VarMeasConfig, is fulfilled during timeToTrigger defined within the VarMeasConfig for this event:
   a remove the measurement reporting entry within the VarMeasReportList for this measId;
   If reportOnLeave is set to true for the corresponding reporting configuration:
      Initiate the measurement reporting procedure, as specified in 1j-35

For reference, whether the UE 1j-01 fulfills the entry (or entering) conditions of Event H1 or Event H2 or the leaving conditions of Event H1 or Event H2 may be based on the following description.

Event H1 (The Aerial UE height is above a threshold)

The UE shall:
1> consider the entering condition for this event to be satisfied when condition H1-1, as specified below, is fulfilled;
1> consider the leaving condition for this event to be satisfied when condition H1-2, as specified below, is fulfilled;

Ms-Hys>Thresh+Offset Inequality H1-1 (Entering condition)

Ms+Hys<Thresh+Offset Inequality H1-2 (Leaving condition)

The variables in the formula are defined as follows:
Ms is the Aerial UE height, not taking into account any offsets.
Hys is the hysteresis parameter (i.e., h1-Hysteresis as defined within ReportConfigNR) for this event.
Thresh is the reference threshold parameter for this event given in MeasConfig (i.e., heightThreshRef as defined within MeasConfig).
Offset is the offset value to heightThreshRef to obtain the absolute threshold for this event. (i.e., h1-ThresholdOffset as defined within ReportConfigNR)
Ms is expressed in meters.
Thresh is expressed in the same unit as Ms.
Event H2 (The Aerial UE height is below a threshold)
The UE shall:
1> consider the entering condition for this event to be satisfied when condition H2-1, as specified below, is fulfilled;
1> consider the leaving condition for this event to be satisfied when condition H2-2, as specified below, is fulfilled;

Ms+Hys<Thresh+Offset Inequality H2-1 (Entering condition)

Ms−Hys>Thresh+Offset Inequality H2-2 (Leaving condition)
The variables in the formula are defined as follows:
Ms is the Aerial UE height, not taking into account any offsets.
Hys is the hysteresis parameter (i.e., h2-Hysteresis as defined within ReportConfigNR) for this event.
Thresh is the reference threshold parameter for this event given in MeasConfig (i.e., heightThreshRef as defined within MeasConfig).
Offset is the offset value to heightThreshRef to obtain the absolute threshold for this event. (i.e., h2-ThresholdOffset as defined within ReportConfigNR)
Ms is expressed in meters.
Thresh is expressed in the same unit as Ms.

In step 1j-35, the UE 1j-01 may report the measurement results to the base station 1j-02.

For example, when the measurement reporting is triggered by the eventH1 or eventH2 in step 1j-30, the UE 1j-01 may transmit the measurement result message (MeasurementReport) to the base station 1j-02. Specifically, the UE 1j-01 may transmit the measurement result message to the base station 1j-02 according to the following procedure.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measurement configuration associated with the SCG;
         4> if reportConfig associated with the measId that triggered the measurement reporting includes reportAddNeighMeas:
         5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rs Type included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report;
         4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig as described in 5.5.5.2, where availability is considered according to the measurement configuration associated with the SCG;
1> if the includeCommonLocationInfo is configured in the corresponding reportConfig for this measId and detailed location information that has not been reported is available, set the content of commonLocationInfo of the locationInfo as follows:
   2> include the location Timestamp;
   2> include the locationCoordinate, if available;
   2> include the velocityEstimate, if available;
   2> include the locationError, if available;
   2> include the locationSource, if available;
   2> if available, include the gnss-TOD-msec,
1> if the includeWLAN-Meas is configured in the corresponding reportConfig for this measId, set the wlan-LocationInfo of the locationInfo in the measResults as follows:
   2> if available, include the Log MeasResultWLAN, in order of decreasing RSSI for WLAN APs;
1> if the includeBT-Meas is configured in the corresponding reportConfig for this measId, set the BT-LocationInfo of the locationInfo in the measResults as follows:
   2> if available, include the Log MeasResultBT, in order of decreasing RSSI for Bluetooth beacons;
1> if the includeSensor-Meas is configured in the corresponding reportConfig for this measId, set the sensor-LocationInfo of the locationInfo in the measResults as follows:
   2> if available, include the sensor-MeasurementInformation;
   2> if available, include the sensor-MotionInformation;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;
1> else:
   2> if the reportType is set to periodical or cli-Periodical or rxTxPeriodical:
      3> remove the entry within the VarMeasReportList for this measId;
      3> remove this measId from the measIdList within VarMeasConfig;
1> else if the UE is in (NG) EN-DC:
   2> if SRB3 is configured and the SCG is not deactivated:
      3> submit the MeasurementReport message via SRB3 to lower layers for transmission, upon which the procedure ends;
   2> else:
      3> submit the MeasurementReport message via E-UTRA embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured and the SCG is not deactivated:
         4> submit the MeasurementReport message via SRB3 to lower layers for transmission, upon which the procedure ends;
      3> else:
         4> submit the MeasurementReport message via SRB1 embedded in NR RRC message ULInformationTransferMRDC as specified in 5.7.2a.3;
   2> else:
      3> submit the MeasurementReport message via SRB1 to lower layers for transmission, upon which the procedure ends;
1> else:
   2> submit the MeasurementReport message to lower layers for transmission, upon which the procedure ends.

For reference, the beam measurement results may be stored in MeasurementReport by the UB 1j-01 according to the following procedure.

For beam measurement information to be included in a measurement report the UE shall:
1> if reportType is set to eventTriggered:
   2> consider the trigger quantity as the sorting quantity if available, otherwise RSRP as sorting quantity if available, otherwise RSRQ as sorting quantity if available, otherwise SINR as sorting quantity;
1> set rsIndexResults to include up to maxNrofRS-IndexesToReport SS/PBCH block indexes or CSI-RS indexes in order of decreasing sorting quantity as follows:
   2> if the measurement information to be included is based on SS/PBCH block:
      3> include within resultsSSB-Indexes the index associated to the best beam for that SS/PBCH block sorting quantity and if absThreshSS-BlocksConsolidation is included in the VarMeasConfig for the measObject associated to the cell for which beams are to be reported, the remaining beams whose sorting quantity is above absThreshSS-BlocksConsolidation;
      3> if includeBeamMeasurements is set to true, include the SS/PBCH based measurement results for the quantities in reportQuantityRS-Indexes for each SS/PBCH block index;
   2> else if the beam measurement information to be included is based on CSI-RS:
      3> include within resultsCSI-RS-Indexes the index associated to the best beam for that CSI-RS sorting quantity and, if absThreshCSI-RS-Consolidation is included in the VarMeasConfig for the measObject associated to the cell for which beams are to be reported, the remaining beams whose sorting quantity is above absThreshCSI-RS-Consolidation;
      3> if includeBeamMeasurements is set to true, include the CSI-RS based measurement results for the quantities in reportQuantityRS-Indexes for each CSI-RS index.

That is, when the measurement reporting is triggered by the event H1 or event H2, the UE 1j-01 according to an embodiment of the present disclosure may have the following characteristics when transmitting the MeasurementReport to the base station 1j-02:
Includes measResultServingCellMOList
Does not include measResultNeighCells
Does not include measResultServFreqListEUTRA-SCG
Does not include measResultServFreqListNR-SCG

For reference, the MeasResults included in the MeasurementReport may have the following ASN.1 structure.

```
MeasResults ::=  SEQUENCE {
  measId MeasId,
  measResultServingMOList  MeasResultServMOList,
  measResultNeighCells CHOICE {
    measResultListNR MeasResultListNR,
    ...,
    measResultListEUTRA MeasResultListEUTRA,
    measResultListUTRA-FDD-r16 MeasResultListUTRA-FDD-r16,
```

| | |
|---|---|
| sl-MeasResultsCandRelay-r17 OCTET STRING | -- Contains PC5 SL- |

```
MeasResultListRelay-r17
  }
OPTIONAL,
  ...,
  [[
```

| | |
|---|---|
| measResultServFreqListEUTRA-SCG | MeasResultServFreqListEUTRA-SCG |

OPTIONAL,

| | |
|---|---|
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
  ]],
  [[
```

| | |
|---|---|
| measResultCellListSFTD-NR | MeasResultCellListSFTD-NR |

```
OPTIONAL
  ]],
  [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
  ]],
  [[
```

| | |
|---|---|
| measResultRxTxTimeDiff-r17 | MeasResultRxTxTimeDiff-r17 |

OPTIONAL,

| | |
|---|---|
| sl-MeasResultServingRelay-r17 | OCTET STRING |

OPTIONAL,
-- Contains PC5 SL-MeasResultRelay-r17

| | |
|---|---|
| ul-PDCP-ExcessDelayResultList-r17 | UL-PDCP-ExcessDelayResultList-r17 |

OPTIONAL,

| | |
|---|---|
| coarseLocationInfo-r17 | OCTET STRING |

OPTIONAL
]]
}

| | |
|---|---|
| MeasResultServMOList ::= | SEQUENCE (SIZE (1..maxNrofServingCells)) OF |

```
MeasResultServMO
MeasResultServeMO ::= SEQUENCE {
  servCellId ServCellIndex,
  measResutlServingCell MeasResultNR,
```

| | |
|---|---|
| measResultBestNeighCell | MeasResultNR |

OPTIONAL,
...
}

| | |
|---|---|
| MeasResultListNR ::= | SEQUENCE (SIZE (1..maxCellReport)) OF |

MeasResultNR
MeasResultNR ::= SEQUENCE {

| | |
|---|---|
| physCellId | PhysCellId |

```
OPTIONAL,
  measResult SEQUENCE {
    cellResults  SEQUENCE{
```

| | |
|---|---|
| resultsSSB-Cell | MeasQuantityResults |

OPTIONAL,

| | |
|---|---|
| resultsCSI-RS-Cell | MeasQuantityResults |

```
OPTIONAL
    },
    rsIndexResults SEQUENCE{
```

| | |
|---|---|
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
    }
OPTIONAL
  },
  ...,
  [[
```

| | |
|---|---|
| cgi-Info | CGI-InfoNR |

```
OPTIONAL
  ]],
  [[
```

| | |
|---|---|
| choCandidate-r17 | ENUMERATED {true} |

OPTIONAL,

| | |
|---|---|
| choConfig-r17 | SEQUENCE (SIZE (1..2)) OF CondTriggerConfig- |

r16 OPTIONAL,
triggeredEvent-r17 SEQUENCE {

| | |
|---|---|
| timeBetweenEvents-r17 | TimeBetweenEvent-r17 |

OPTIONAL,

| | |
|---|---|
| firstTriggeredEvent-r17 | ENUMERATED {condFirstEvent, |

```
condSecondEvent} OPTIONAL
    }
OPTIONAL
  ]]
}
```

| | |
|---|---|
| MeasResultListEUTRA ::= | SEQUENCE (SIZE (1..maxCellReport)) OF |

```
MeasResultEUTRA
MeasResultEUTRA ::=  SEQUENCE {
  eutra-PhysCellId PhysCellId,
  measResult MeasQuantityResultsEUTRA,
```

| | |
|---|---|
| cgi-Info | CGI-InfoEUTRA |

OPTIONAL,
...
}

| | |
|---|---|
| MultiBandInfoListEUTRA ::= | SEQUENCE (SIZE (1..maxMultiBands)) OF |

FreqBandIndicatorEUTRA
MeasQuantityResults ::= SEQUENCE {

| | |
|---|---|
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}
MeasQuantityResultsEUTRA ::= SEQUENCE {

| | |
|---|---|
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE (1..maxNrofIndexesToReport2)) OF |

ResultsPerSSB-Index
ResultsPerSSB-Index ::= SEQUENCE {
ssb-Index SSB-Index,

| | |
|---|---|
| ssb-Results | MeasQuantityResults |

OPTIONAL
}

| | |
|---|---|
| ResultsPerCSI-RS-IndexList::= | SEQUENCE (SIZE (1..maxNrofIndexesToReport2)) OF |

ResultsPerCSI-RS-Index
ResultsPerCSI-RS-Index ::= SEQUENCE {
csi-RS-Index CSI-RS-Index,

| | |
|---|---|
| csi-RS-Results | MeasQuantityResults |

OPTIONAL
}
MeasResultServFreqListEUTRA-SCG ::= SEQUENCE (SIZE (1..maxNrofServingCellsEUTRA)) OF
MeasResult2EUTRA
MeasResultServFreqListNR-SCG ::= SEQUENCE (SIZE (1..maxNrofServingCells)) OF MeasResult2NR

| | |
|---|---|
| MeasResultListUTRA-FDD-r16 ::= | SEQUENCE (SIZE (1..maxCellReport)) OF |

```
MeasResultUTRA-FDD-r16
MeasResultUTRA-FDD-r16 ::= SEQUENCE {
  physCellId-r16 PhysCellIdUTRA-FDD-r16,
  measResult-r16 SEQUENCE {
    utra-FDD-RSCP-r16 INTEGER (−5..91) OPTIONAL,
    utra-FDD-EcN0-r16 INTEGER (0..49) OPTIONAL
  }
}
MeasResultForRSSI-r16 ::= SEQUENCE {
  rssi-Result-r16 RSSI-Range-r16,
  channelOccupancy-r16 INTEGER (0..100)
}
MeasResultCLI-r16 ::= SEQUENCE {
```

| | |
|---|---|
| measResultListSRS-RSRP-r16 | MeasResultListSRS-RSRP-r16 |

OPTIONAL,

| | |
|---|---|
| measResultListCLI-RSSI-r16 | MeasResultListCLI-RSSI-r16 |

```
OPTIONAL
}
MeasResultListSRS-RSRP-r16 ::= SEQUENCE (SIZE (1.. maxCLI-Report-r16)) OF MeasResultSRS-
RSRP-r16
MeasResultSRS-RSRP-r16 ::= SEQUENCE {
  srs-ResourceId-r16 SRS-ResourceId,
  srs-RSRP-Result-r16 SRS-RSRP-Range-r16
}
MeasResultListCLI-RSSI-r16 ::= SEQUENCE (SIZE (1.. maxCLI-Report-r16)) OF MeasResultCLI-
RSSI-r16
MeasResultCLI-RSSI-r16 ::= SEQUENCE {
  rssi-ResourceId-r16 RSSI-ResourceId-r16,
  cli-RSSI-Result-r16 CLI-RSSI-Range-r16
}
UL-PDCP-DelayValueResultList-r16 ::= SEQUENCE (SIZE (1..maxDRB)) OF UL-PDCP-
DelayValueResult-r16
UL-PDCP-DelayValueResult-r16 ::= SEQUENCE {
  drb-Id-r16 DRB-Identity,
  averageDelay-r16 INTEGER (0..10000),
  ...
}
UL-PDCP-ExcessDelayResultList-r17 ::= SEQUENCE (SIZE (1..maxDRB)) OF UL-PDCP-
ExcessDelayResult-r17
UL-PDCP-ExcessDelayResult-r17 ::= SEQUENCE {
  drb-Id-r17 DRB-Identity,
  excessDelay-r17 INTEGER (0..31),
  ...
}
TimeBetweenEvent-r17 ::= INTEGER (0..1023)
-- TAG-MEASRESULTS-STOP
-- ASN1STOP
```

FIG. 1K is a flowchart of a process in which the uncrewed aerial vehicle (UAV) UE efficiently reports a MeasurementReport to the base station in the next-generation mobile communication system according to an embodiment of the present disclosure.

The uncrewed aerial vehicle (UAV) UE may refer to the UE capable of flight. Referring to FIG. 1K, in step 1k-05, a UAV UE 1k-01 may establish a radio resource control (RRC) connection with an NR base station (gNB) 1k-02 and may be in an RRC connected mode (RRC_CONNECTED).

In step 1k-10, the UAV UE 1k-01 may report the UE capability to the base station 1k-02.

For example, the UE 1k-01 may transmit the UE capability information message (UECapability Information) to the base station 1k-02. This may follow at least one of the above-described embodiments.

In step 1k-15, the base station 1k-02 may transmit a predetermined RRC message (e.g., RRCReconfiguration) containing measurement configuration information (MeasConfig) to the UAV UE 1k-01. This may follow at least one of the above-described embodiments.

The base station according to an embodiment of the present disclosure may be configured to initiate the measurement reporting procedure when the UE simultaneously fulfills both an altitude-based event (e.g., eventH1 or eventH2) and a signal-based event (e.g., eventA3, eventA4, eventA5) through the measurement configuration information.

In step 1k-20, the UE 1k-01 may perform the measurement based on the measurement configuration information received in step 1k-15.

In step 1k-25, the UE may determine whether a measurement report should be triggered based on the measurement configuration information received in step 1k-20.

Specifically, when measurement reporting triggering for eventHx and eventAx in the above-described embodiment is simultaneously fulfilled, the UE may determine whether the measurement report should be triggered.

In step 1k-30, the UE 1k-01 may report the measurement results to the base station 1k-02.

For example, when the measurement reporting is triggered in step 1k-25, the UE 1k-01 may transmit the measurement result message (MeasurementReport) to the base station 1k-02. This may follow at least one of the above-described embodiments.

In step 1k-35, the UE 1k-01 may apply at least one of the numberOfTriggeringCells or a4-Threshold associated with a new altitude (or altitude range) based on the altitude of the UE 1k-01.

Specifically, when the UE 1k-01 flies at a (new) altitude different from the altitude at which the UE was flying in step 1k-20, step 1k-25, or step 1k-30 and enters the new altitude or altitude range configured in step 1k-15, the UE may apply a numberOfTriggeringCells (and/or a4-Threshold) different from the numberOfTriggeringCells (and/or the a4-Threshold) applied in step 1k-20 or step 1k-25 and perform a UE operation associated therewith. This may follow at least one of the above-described embodiments.

It may be determined whether the measurement report should be triggered. This may follow step 1k-25.

In step 1k-40, the UE 1k-01 may report the measurement results to the base station 1k-02.

For example, in step 1k-35, when the measurement reporting procedure is initiated, the UE 1k-01 may transmit the measurement result message (MeasurementReport) to the base station 1k-02 according to the following procedures.

FIG. 1L is a block diagram illustrating an internal structure of a terminal according to an embodiment of the present disclosure.

Referring to the drawing, the terminal may include a radio frequency (RF) processing unit 1l-10, a baseband processing unit 1l-20, a storage unit 1l-30, and a control unit 1l-40.

The RF processing unit 1l-10 may perform functions for transmitting and receiving signals via a wireless channel, such as signal band conversion and amplification. That is, the RF processing unit 1l-10 may up-convert a baseband signal provided from the baseband processing unit 1l-20 into an RF band signal and transmit the RF band signal via an antenna, and down-convert the RF band signal received via the antenna into the baseband signal. For example, the RF processing unit 1l-10 may include a transmission filter, a reception filter, an amplifier, a mixer, an oscillator, a digital to analog converter (DAC), an analog to digital converter (ADC), and the like. Although only one antenna is illustrated in the drawing, the terminal may be provided with a plurality of antennas. In addition, the RF processing unit 1l-10 may include a plurality of RF chains.

Furthermore, the RF processing unit 1l-10 may perform beamforming. For the beamforming, the RF processing unit 1l-10 may adjust the phase and amplitude of each signal transmitted and received through the plurality of antennas or antenna elements. In addition, the RF processing unit may perform MIMO and receive multiple layers during MIMO operation.

The baseband processing unit 1l-20 may perform a conversion function between the baseband signal and the bit string according to physical layer specifications of the system. For example, during the data transmission, the baseband processing unit 1l-20 may encode and modulate the transmission bit string to generate complex symbols. In addition, during the data reception, the baseband processing unit 1l-20 may demodulate and decode the baseband signal provided from the RF processing unit 1l-10 to reconstruct the received bit string.

For example, according to the orthogonal frequency division multiplexing (OFDM) scheme, during the data transmission, the baseband processing unit 1l-20 may encode and modulate the transmission bit string to generate complex symbols, map the complex symbols to subcarriers, and then constitute OFDM symbols through an inverse fast Fourier transform (IFFT) operation and a cyclic prefix (CP) insertion. In addition, during the data reception, the baseband processing unit 111-20 may segment the baseband signal provided from the RF processing unit 1l-10 into OFDM symbol units, reconstruct signals mapped to subcarriers through a fast Fourier transform (FFT), and then reconstruct the received bit string through demodulation and decoding.

The baseband processing unit 1l-20 and the RF processing unit 1l-10 may transmit and receive signals as described above. Accordingly, the baseband processing unit 1l-20 and the RF processing unit 1l-10 may be referred to as a transmission unit, a reception unit, a transceiver, or a communication unit.

Furthermore, at least one of the baseband processing unit 1l-20 and the RF processing unit 1l-10 may include a plurality of communication modules to support a plurality of respectively different radio access technologies. In addition, at least one of the baseband processing unit 1l-20 and the RF processing unit 1l-10 may include respectively different communication modules to process signals in respectively different frequency bands. For example, the respectively different radio access technologies may include wireless LAN (e.g., IEEE 802.11), cellular networks (e.g., LTE), etc. In addition, the respectively different frequency bands may include a super high frequency (SHF) (e.g., 2.NRHz, NRhz) band and a millimeter wave (mmWave) (e.g., 60 GHz) band.

The storage unit 1l-30 may store data such as basic programs, application programs, and configuration information for the operation of the terminal. In particular, the storage unit 1l-30 may store information related to a second access node that performs wireless communication using a second radio access technology. Furthermore, the storage unit 1l-30 may provide the stored data upon request from the control unit 1l-40.

The control unit 1l-40 may control the overall operations of the terminal. For example, the control unit 1l-40 may transmit and receive signals through the baseband processing unit 1l-20 and the RF processing unit 1l-10. In addition, the control unit 1l-40 may write and read data to and from the storage unit 1l-40.

To this end, the control unit 1l-40 may include at least one processor. For example, the control unit 1l-40 may include a communication processor (CP) that performs control for communication and an application processor (AP) that controls upper layers such as application programs.

FIG. 1M is a block diagram illustrating an internal structure of a base station according to an embodiment of the present disclosure.

As illustrated in the drawing, the base station may be configured to include an RF processing unit 1m-10, a baseband processing unit 1m-20, a backhaul communication unit 1m-30, a storage unit 1m-40, and a control unit 1m-50. The RF processing unit 1m-10 may perform functions for transmitting and receiving signals via a wireless channel, such as signal band conversion and amplification. That is, the RF processing unit 1m-10 may up-convert a baseband signal provided from the baseband processing unit 1m-20 into an RF band signal and transmit the RF band signal via an antenna, and down-convert the RF band signal received via the antenna into the baseband signal. For example, the RF processing unit 1m-10 may include a transmission filter, a reception filter, an amplifier, a mixer, an oscillator, a DAC, an ADC, and the like. Although only one antenna is illustrated in the drawing, the first access node may be provided with a plurality of antennas. In addition, the RF processing unit 1m-10 may include the plurality of RF chains.

Furthermore, the RF processing unit 1m-10 may perform beamforming. For the beamforming, the RF processing unit 1m-10 may adjust the phase and amplitude of each signal transmitted and received through the plurality of antennas or antenna elements. The RF processing unit may perform a downlink MIMO operation by transmitting one or more layers.

The baseband processing unit 1m-20 may perform the conversion function between the baseband signal and the bit string according to physical layer specifications of the first radio access technology. For example, during the data transmission, the baseband processing unit 1m-20 may encode and modulate the transmission bit string to generate the complex symbols. In addition, during the data reception, the baseband processing unit 1m-20 reconstructs the received bit string by demodulating and decoding the baseband signal provided from the RF processing unit 1m-10. For example, in the case of the OFDM scheme, during the data transmission, the baseband processing unit 1m-20 may encode and modulate a transmission bit string to generate complex symbols, map the complex symbols to subcarriers, and then constitute the OFDM symbols through the IFFT operation and CP insertion. In addition, during the data reception, the baseband processing unit 1m-20 may segment the baseband signal provided from the RF processing unit 1m-10 into the OFDM symbol units, reconstruct signals mapped to the subcarriers through the FFT operation, and then reconstruct the received bit string through the demodulation and decoding.

The baseband processing unit 1m-20 and the RF processing unit 1m-10 may transmit and receive the signals as described above. Accordingly, the baseband processing unit 1m-20 and the RF processing unit 1m-10 may be referred to as a transmission unit, a reception unit, a transceiver, a communication unit, or a wireless communication unit.

The backhaul communication unit 1m-30 may provide an interface for communicating with other nodes within the network. That is, the backhaul communication unit 1m-30 may convert a bit string transmitted from a serving base station to another node, such as an auxiliary base station, a core network, etc., into a physical signal, and also convert a physical signal received from the other node into a bit string.

The storage unit 1m-40 may store data such as basic programs, application programs, and configuration information for the operation of the serving base station. In particular, the storage unit 1m-40 may store information on bearers allocated to an accessed terminal, measurement results reported from the accessed terminal, and the like. In addition, the storage unit 1m-40 may store information that serves as a basis for determining whether to provide or terminate multi-connectivity to a terminal. Furthermore, the storage unit 1m-40 may provide the stored data upon request from the control unit 1m-50.

The control unit 1m-50 may control the overall operations of the serving base station. For example, the control unit 1m-50 may transmit and receive signals through the baseband processing unit 1m-20 and the RF processing unit 1m-10, or through the backhaul communication unit 1m-30. In addition, the control unit 1m-50 writes and reads data to and from the storage unit 1m-40. To this end, the control unit 1m-50 may include at least one processor.

Methods according to the embodiments described in the claims or specifications of the present disclosure may be implemented in the form of hardware, software, or a combination of hardware and software.

When implemented in software, a computer-readable storage medium storing one or more programs (software modules) may be provided. One or more programs stored in the computer-readable storage medium are configured for execution by one or more processors in an electronic device. One or more programs include instructions for causing an electronic device to execute methods according to embodiments described in a claim or specification of the present disclosure.

Such programs (software modules, software) may be stored a random access memory, a non-volatile memory including flash memory, a read only memory (ROM), an electrically erasable programmable read only memory (EEPROM), a magnetic disc storage device, a compact disc-ROM (CD-ROM), digital versatile Discs (DVDs), any other form of optical storage device, or a magnetic cassette. Alternatively, it may be stored in a memory composed of a combination of some or all thereof. In addition, each configuration memory may be included in plurality.

In addition, the program may be stored in an attachable storage device that may be accessed through a communication network such as the Internet, the Intranet, a local area network (LAN), wireless LAN (WLAN), or a storage area network (SAN), or a combination thereof. Such a storage device may access the apparatus implementing an embodiment of the present disclosure through an external port. In addition, a separate storage device on the communication network may access the apparatus implementing the embodiment of the present disclosure.

In the specific embodiments of the present disclosure described above, elements included in the disclosure are expressed in the singular or plural according to the specific embodiments presented. However, the singular or plural expression is appropriately selected for the context presented for convenience of description, and the present disclosure is not limited to the singular or plural components, and even if the component is expressed in plural, the component is configured in singular or even if the component is expressed in singular, the element may be configured in plural.

Meanwhile, the embodiments of the present disclosure disclosed in this specification and drawings are merely specific examples presented to easily describe the technical contents of the present disclosure and to help understanding of the present disclosure, and are not intended to limit the scope of the present disclosure. That is, it is obvious to a person having ordinary skill in the art to which the present disclosure pertains that other modifications based on the technical idea of the present disclosure are possible. In addition, each embodiment may be combined with each other and operated as needed.

Meanwhile, the order of description in the drawings describing the method of the present disclosure does not necessarily correspond to the order of execution, and the order of precedence may be changed or executed in parallel.

Alternatively, the drawings describing the method of the present disclosure may omit some components and include only some components, without departing from the essence of the present disclosure.

In addition, the method of the present disclosure may be executed by combining some or all of the contents included in each embodiment, without departing from the essence of the present disclosure.

Various embodiments of the present disclosure have been described above. The foregoing description of the present disclosure is for illustrative purposes, and the embodiments of the present disclosure are not limited to the disclosed embodiments. It will be understood by those of ordinary skill in the art to which the present disclosure pertains that various modifications can be made in other specific forms without departing from the technical spirit or essential features of the present disclosure. It should be interpreted that the scope of the present disclosure is defined by the following claims rather than the detailed description and all modifications or alterations deduced from the meaning, the scope, and equivalences of the claims are included in the scope of the present disclosure.

1. A method performed by a terminal of a wireless communication system, comprising:
acquiring, from a base station, measurement configuration information including altitude-related information;
performing measurement on at least one cell for at least one altitude based on the altitude-related information; and
reporting a measurement result for the at least one cell to the base station based on the altitude-related information,
wherein the altitude-related information includes at least one altitude threshold value for determining whether to trigger the reporting of the at least one measurement result.

2. The method of claim 1, wherein the altitude-related information further includes information on the number of cells (the number of triggering cells) related to the at least one measurement.

3. The method of claim 1, wherein the measurement result for at least one cell measured at a first altitude is deleted after the terminal enters a second altitude and after a first timer, which was running at the first altitude, has expired, or
the measurement result for at least one cell measured at the first altitude is deleted after the terminal enters the second altitude and after a second timer, which was newly running at a second altitude, has expired.

4. The method of claim 1, wherein the measurement result for at least one cell measured at a first altitude is deleted when the terminal enters a second altitude, or
the measurement result for at least one cell measured at the first altitude is deleted according to a configuration of the base station.

5. The method of claim 1, wherein, when the terminal enters a second altitude, starting of a periodic reporting timer is stopped and a time to trigger related to a measurement result for at least one cell measured at a first altitude is reset.

6. The method of claim 1, wherein, when the terminal enters a second altitude, starting of a periodic reporting timer is maintained and a time to trigger related to a measurement result for at least one cell measured at a first altitude is maintained.

7. A method performed by a base station of a wireless communication system, comprising:
transmitting, to a terminal, measurement configuration information including altitude-related information; and
receiving, from the terminal, a measurement result for at least one cell measured based on the altitude-related information,
wherein the altitude-related information includes at least one altitude threshold value related to whether to trigger reporting of the at least one measurement result.

8. The method of claim 7, wherein the altitude-related information further includes information on the number of cells (the number of triggering cells) related to the at least one measurement.

9. A terminal of a wireless communication system, comprising:
a transceiver configured to transmit and receive a signal; and
a control unit,
wherein the control unit acquires measurement configuration information including altitude-related information from a base station,
performs measurement on at least one cell for at least one altitude based on the altitude-related information,
reports a measurement result for the at least one cell to the base station based on the altitude-related information, and
the altitude-related information includes at least one altitude threshold value for determining whether to trigger the reporting of the at least one measurement result.

10. The terminal of claim 9, wherein the altitude-related information further includes information on the number of cells (the number of triggering cells) related to the at least one measurement.

11. The terminal of claim 9, wherein the measurement result for at least one cell measured at a first altitude is deleted after the terminal enters a second altitude and after a first timer, which was running at the first altitude, has expired, or
the measurement result for at least one cell measured at the first altitude is deleted after the terminal enters the second altitude and after a second timer, which was newly running at a second altitude, has expired.

12. The terminal of claim 9, wherein the measurement result for at least one cell measured at a first altitude is deleted when the terminal enters a second altitude, or
the measurement result for at least one cell measured at the first altitude is deleted according to a configuration of the base station.

13. The terminal of claim 9, wherein, when the terminal enters a second altitude, starting of a periodic reporting timer is stopped and a time to trigger related to a measurement result for at least one cell measured at a first altitude is reset, or
when the terminal enters a second altitude, starting of a periodic reporting timer is maintained and a time to trigger related to a measurement result for at least one cell measured at a first altitude is maintained.

14. A base station of a wireless communication system, comprising:
a transceiver configured to transmit and receive a signal; and
a control unit,
wherein the control unit transmits, to a terminal, measurement configuration information including altitude-related information, and
receives, from the terminal, a measurement result for at least one cell measured based on the altitude-related information, and
the altitude-related information includes at least one altitude threshold value related to whether to trigger reporting of the at least one measurement result.

15. The base station of claim 14, wherein the altitude-related information further includes information on the number of cells (the number of triggering cells) related to the at least one measurement.
